(19) United States
(12) Patent Application Publication
(10) Pub. No.: US 2025/0340034 A1
(43) Pub. Date: Nov. 6, 2025

(54) METHOD AND SYSTEM FOR PROVIDING VISUALLY ENHANCED, FUNCTIONALLY TRANSFORMED PACKAGING USING MOLDED FIBER OR STARCH

(71) Applicant: TETONIA, LLC, Atlanta, GA (US)

(72) Inventor: GARY ROBINSON, Atlanta, GA (US)

(21) Appl. No.: 19/004,772

(22) Filed: Dec. 30, 2024

Related U.S. Application Data
(60) Provisional application No. 63/643,359, filed on May 6, 2024.

(51) Int. Cl. B30B 15/02; B30B 11/02

(52) U.S. Cl. CPC B30B 15/022; B30B 11/02

(57) ABSTRACT

Various implementations include a method for producing a molded fiber or starch product. The method includes obtaining a label or preform; obtaining a male or female tool, wherein a recess is defined in a surface of the male or female tool that has a geometry corresponding to the geometry of the label or preform; disposing the label or preform within the recess of the one of the male or female tool; obtaining the other of the female or male tool; pressing the male tool into the female tool such that a fiber-starch material is sandwiched between the label or preform and the other of the female or male tool to form the molded fiber or starch product with the label or preform coupled to a surface; and curing the product such that the label or preform forms an augmented surface of the product once cured.

### FIELD OF INVENTION

The field of the invention relates to the use of an in-mold label or pre-form to functionally or visually enhance the performance for rigid, formed, molded fiber and starch-based consumer packaging or containers. The enhanced containers or packages can be used for consumer goods, food-stuffs, medical and pharmaceutical products, and industrial products. The devices, systems, and methods disclosed herein provide for a mechanism for molded fiber and starch packaging to have customizable and augmented surface characteristics on either the inside, or outside of the packaging or container. The surface augmentation can be used to enhance the packaging or container with high impact graphics, enhanced structural characteristics, enhanced liquid absorbing properties, provide functional barrier to protect a product from either internal or external environmental exposure, provide sealing properties, provide reflective surfaces for redirecting energy, warming, and for crisping food-stuffs, and integrate electronic displays for conveying alpha-numeric text messages to consumers.

### BACKGROUND

Plastics, and the bioaccumulation of plastic waste, is one of the most significant global crisis impacting the health of the planet. The consumption and growth for the use of plastics has been exponential since the technology's introduction in the 1950s. Global production is now estimated at over 280 million tons per year. In the packaging domain, it is estimated 78 million tons per year are produced with 98% from virgin feedstocks. Of this material, 2% is estimated for like-for-like recycling and 8% of the material down-cycled to a lower value. An alarming 32% is leaking into the environment. The plastics leaked into the environment create a multitude of economic, social, health, and environmental damages. The impacts are globally systemic and locally acute, most often with economically vulnerable communities. The pervasive nature of the plastics results in them entering the air, soil, water, and food chain.

For consumer packaging applications, most plastics used today are not designated as recyclable. A 2024 study by The Recycling Partnership shows that less than half of plastic packaging is considered recyclable. While many brands have committed to redesigning plastic packaging systems to be recyclable by 2025, as of 2024 only 36% have completed this goal. This indicates a fundamental need for change, innovation, and compelling alternatives.

Globally, emerging policy is being established to build system solutions to close gaps in the circularity model. This policy commonly includes what is referred to as eco-modulation, or the escalating and de-escalating of financial incentives associated with the collection and recycling of materials. Materials that are not recycled, or not recyclable under these programs receive increased fiscal burden.

Fundamental change is needed. Thus, there is a need in the art to deliver pragmatic and scalable solutions to provide users of rigid plastics for consumer goods with an effective alternative.

Materials from natural and renewable resources create a positive pathway to support growth and stay within planetary boundaries. With regenerative agricultural, fast-growing crops, sea-based agriculture, certified sustainably managed forestry, vertical farming, usable agricultural-waste, and recycling, there are ample supplies for renewable fibers to support market demand and growth. These fibers can be sustainably harvested and converted to consumer products with a beginning of life and end of life aligned to earth's natural lifecycles. Such solutions can be recycled or composted to go back to delivering nutrient value and build healthy soils. The growth of such raw materials can also positively support the reduction of CO₂ emissions in the atmosphere through the contribution of oxygen in photosynthesis and the entombing of carbon into the soils.

Packaging also plays a critical role in sustainability through the protection of the product. A product damaged or spoiled is a product wasted. The packaging role is typically integrated with the product in the final phase of delivery for the use application. Therefore, the entire economical value, and sustainability impact of the product contained within is dependent on the package performing the critical function of protection. Protection can include a multitude of attributes. Commonly, protection is needed against atmosphere, temperature, water, grease, or light, as well as physical strength against applied forces (e.g., forces from transporting goods). Packaging may protect against external environmental conditions interacting with the product or internal product attributes interacting or exiting the package system.

Communication is often a critical role in the packaging function and its sustainability. Consumers need to understand what is contained within the package and the benefits of such products. Further, there are safety and regulatory attributes that require clear communication such as ingredient lists, warning labels, use instructions, and recycling instructions.

Currently, packaging solutions such as molded fiber and starch can displace plastics. However, they lack functionality for attributes such as printability, barrier, sealing, or strength. These limitations restrict the market use, consumer adoption, and lack the functional performance to effectively displace plastics. The limitations result in suppressed economic value for the products. Thus, there is a need in the art to enhance the value of molded fiber and starch products to provide a competitive alternative to rigid plastics.

Existing molded fiber and starch solutions often lack a functional barrier. Existing barrier technologies are commonly limited to surface water and grease. Existing solutions use toxic, forever chemicals such as PFAS and the family of fluorinated chemistries in the wet-end of the manufacturing process to deliver a grease barrier. Alternative grease barrier solutions are available through post-forming treatments such as spray-applied aqueous coatings or through extruded plastic film lamination solutions.

Existing molded fiber and starch solutions also lack sealing capabilities. A functional barrier commonly requires high quality and consistent sealing properties. Sealing properties also contribute value to a packaging system for product containment, tamper evidence, or tamper resistance. Existing molded fiber and starch solutions rely on secondary sealing systems such as adhesives. These solutions usually lack technical sophistication to perform many of the functional requirements for consumer packaging. As an example, these solutions lack the ability to have a high-barrier seal. Another alternative for existing molded fiber or starch to have sealing characteristics is to apply an extruded plastic over the surface via a transfer web. While this can generate a sealing surface, the manufacturing process can negatively impact other desired properties such as recyclability.

Furthermore, existing molded fiber and starch solutions lack the ability to deliver highly-valued print for consumer applications. Due to rough and absorbent surfaces and the forming processes, printing solutions are limited to post forming pad printing, laser, or ink-jet printing, all of which have low resolution. Some applications are suitable for post-forming pressure-sensitive label applications. These solutions can create operational challenges for placement and bond adhesion.

Some existing molded fiber and starch solutions lack desired strength or can benefit by strength enhancements. Solutions such as molded starch often can be brittle. While molded fiber can be very strong, it can benefit by enhanced strength characteristics reinforced in discrete locations. Molded fiber and starch would further benefit by improved flexural strength or hinge strength.

Many of the existing molded fiber and starch solutions also lack absorbent properties. Molded fiber and starch, when exposed to fluids, will either absorb such materials and degrade the base structure, or, if a surface barrier is applied, the fluids will be contained. However, these contained fluids will be suspended on the surface barrier and flow freely across the surface. The ability to absorb fluids without degrading the structural integrity would benefit the functional use of molded fiber or starch.

Lastly, existing molded fiber and starch solutions lack reflective properties. Molded fiber and starch absorb thermal radiation, sound radiation, and electro-mechanical signal radiation. The ability to create reflective surfaces on molded fiber and starch can offer technical and commercial value.

Thus, a need exists for a molded fiber and starch solution that addresses the above noted issues.

### SUMMARY

Various implementations include a method for producing a molded fiber or starch product. The method includes obtaining a label or a preform having a first geometry; obtaining one of a male tool or a female tool, wherein a recess is defined in an external surface of the male tool or an internal surface of the female tool, wherein the recess has a second geometry that corresponds to the first geometry of the label or preform; disposing the label or preform within the recess of the one of the male tool or the female tool; obtaining another of the female tool or the male tool; pressing the male tool into the female tool such that a fiber-starch material is sandwiched between the label or preform and the other of the female tool or the male tool in order to form the molded fiber or starch product with the label or preform coupled to a surface of the molded fiber or starch product; and curing the molded fiber or starch product such that the label or preform forms an augmented surface of the molded fiber or starch product once cured.

In some implementations, the one of the male tool or the female tool includes a male tool. In some implementations, the one of the male tool or the female tool includes a female tool.

In some implementations, the label or preform includes a plurality of layers. In some implementations, the label or preform includes paper. In some implementations, one of the layers includes metal. In some implementations, one of the layers includes an adhesive.

In some implementations, the fiber-starch material is recyclable, compostable, or biodegradable. In some implementations, the fiber-starch material includes cellulose fibers made from virgin fibers, recycled paper, sugar-cane residues, corn stover, sugar beet residues, coconut husk including coir dust, cotton linters, citrus residues, sawdust, or particulated fibers prepared from coagula or extruded fibers of water-insoluble biopolymers including calcium alginate, hemp, miscanthus, elephant grass, rice straw, wheat straw, bagasse, switch grass, or any other natural fiber.

In some implementations, the second geometry of the recess is the same as the first geometry of the label or preform.

In some implementations, the recess defined by the one of the male tool and the female tool is a first recess. In some implementations, the label or preform is a first label or first preform. In some implementations, the other of the female tool or the male tool defines a second recess. In some implementations, method further includes disposing a second label or a second preform within the second recess prior to pressing the male tool into the female tool. In some implementations, the fiber-starch material is sandwiched between the second label or second preform and the one of the male tool or the female tool in order to form the molded fiber or starch product with the label or preform coupled to a second surface of the molded fiber or starch product. In some implementations, when the molded fiber or starch product is cured, the second label or second preform forms a second augmented surface of the molded fiber or starch product once cured.

Various other implementations include a package including a molded fiber or starch. The package has two or more surfaces. A label or a preform is at least partially recessed into and coupled to one of the two or more surfaces.

In some implementations, the label or preform is flush with the one of the two or more surfaces.

In some implementations, the label or preform has a first geometry. In some implementations, the recess of the one of the two or more surfaces has a second geometry that corresponds to the first geometry of the label or preform. In some implementations, the second geometry of the recess is the same as the first geometry of the label or preform.

In some implementations, the one of the two or more surfaces is an interior surface.

In some implementations, the label or preform includes a plurality of layers. In some implementations, the label or preform includes paper. In some implementations, the label or preform includes metal. In some implementations, the label or preform includes an adhesive. In some implementations, the label or preform includes a reflective surface. In some implementations, the label or preform includes an absorbent material. In some implementations, the label or preform includes a water resistant, waterproof, or airtight material. In some implementations, the label or preform includes a sealable surface. In some implementations, the label or preform includes a material stronger than the molded fiber or starch. In some implementations, the label or preform includes electronic components, a power supply, or a display. In some implementations, the fiber-starch material includes cellulose fibers made from virgin fibers, recycled paper, sugar-cane residues, corn stover, sugar beet residues, coconut husk including coir dust, cotton linters, citrus residues, sawdust, or particulated fibers prepared from coagula or extruded fibers of water-insoluble biopolymers including calcium alginate, hemp, miscanthus, elephant grass, rice straw, wheat straw, bagasse, switch grass, or any other natural fiber.

In some implementations, the label or preform is at least partially recessed into and coupled to two of the two or more surfaces. In some implementations, the label or preform is continuous across the two of the two or more surfaces.

In some implementations, the label of preform is a first label or preform. In some implementations, the package further includes a second label or preform at least partially recessed into and coupled to a second of the two or more surfaces.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIGS. 1A and 1B are perspective views of a package/container modified for graphical and visual enhancements, according to one implementation.

FIG. 2 is a perspective view of a package/container modified for functional barrier enhancements, according to another implementation.

FIGS. 3A and 3B are perspective views of a package/container modified for strength enhancements, according to other implementations.

FIG. 4 is a perspective view of a package/container modified for absorption properties, according to another implementation.

FIG. 5 is a perspective view of a package/container modified for reflective characteristics, according to another implementation.

FIG. 6 is a perspective view of a package/container modified for electronic circuitry, battery, or display, according to another implementation.

FIG. 7A is a perspective view of wet molded fiber, flatbed forming, according to some implementations.

FIG. 7B is a perspective view of wet molded fiber, rotary forming, according to some implementations.

FIG. 7C is a perspective view of baked molded fiber/starch, flatbed forming, according to some implementations.

FIG. 7D is a perspective view of baked molded fiber/starch, extrusion, according to some implementations.

FIG. 7E is a perspective view of dry molded fiber, according to some implementations.

FIG. 8A is a perspective view of a female mold tooling with panel for flush in mold label placement, according to some implementations.

FIG. 8B is a perspective view of male mold tooling with panel for flush in-mold label placement, according to some implementations.

FIG. 9A is a perspective view of flat in-mold label applied to exterior of molded fiber or starch body, according to another implementation.

FIG. 9B is a perspective view of a 3D pre-form inserted into a female tool, according to some implementations.

FIG. 9C is a perspective view of a 3D pre-form inserted onto a male tool, according to some implementations.

FIG. 10A is a side view of a manufacturing schematic for press forming to create a 3D pre-form, according to some implementations.

FIG. 10B is a side view of a die line for a flat label, according to some implementations.

FIG. 10C is a top view of a die line for a 3D pre-form, according to some implementations.

FIG. 11A is a perspective view of wet molded fiber tooling with focus on drying, according to some implementations.

FIG. 11B is a detail side view of a molded fiber or starch interface with label or pre-form, according to some implementations.

FIG. 12A is a detail side view of a layer drawing for in-mold label with metallized paper and barrier surface, according to some implementations.

FIG. 12B is a detail side view of an in-mold label to provide structural enhancement, according to some implementations.

FIG. 12C is a detail side view of an in-mold label with high impact graphics and printing, according to some implementations.

FIG. 12D is a detail side view of an in-mold label with integrated electronics to include OLED display, according to some implementations.

FIG. 13A is a perspective view of a magazine stack for pre-cut flat labels, according to some implementations.

FIG. 13B is a perspective view of magazine stack for pre-forms, according to some implementations.

FIG. 14A is a perspective view of a robotic arm aperture capturing flat label, according to some implementations.

FIG. 14B is a perspective view of a robotic arm aperture capturing pre-form, according to some implementations.

FIG. 15 is a perspective view of a robotic arm placing label into tooling, according to some implementations.

FIG. 16 is a flow chart showing the use of in-mold label or pre-form to functionally or visually enhance performance for rigid, formed, molded fiber and starch-based containers, according to some implementations.

FIG. 17 is a flow chart showing the augmentation of the female tool for label, according to some implementations.

FIG. 18 is a flow chart showing the augmentation of the male tool for label, according to some implementations.

FIG. 19 is a flow chart showing the augmentation of the female tool for preform, according to some implementations.

FIG. 20 is a flow chart showing the augmentation of the male tool for preform, according to some implementations.

FIG. 21 is a flow chart showing the placement of label into female tool, according to some implementations.

FIG. 22 is a flow chart showing the placement of label onto male tool, according to some implementations.

FIG. 23 is a flow chart showing the placement of preform into female tool, according to some implementations.

FIG. 24 is a flow chart showing the placement of preform onto male tool, according to some implementations.

FIG. 25 is a flow chart showing the making a preform, according to some implementations.

FIG. 26 is a flow chart showing the augmentation of the female tool for label, according to some implementations.

FIG. 27 is a flow chart showing the augmentation of the male tool for label, according to some implementations.

### DETAILED DESCRIPTION

The word “exemplary” is used herein to mean “serving as an example, instance, or illustration.” Any aspect described herein as “exemplary” is not necessarily to be construed as preferred or advantageous over other aspects. In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

The devices, systems, and methods disclosed herein relate to consumer packaged goods, and more specifically to delivering a functional solution to advance sustainability and displace plastics with natural, renewable and recyclable alternatives made from fibers and starches.

The various methods disclosed herein integrate existing technologies to deliver transformative economic and functional value for molded fiber and starches as a natural, renewable, recyclable, and compostable alternative to plastics. Existing technologies are available to create high-barrier, recyclable paper, high quality print on paper, a sealable surface on paper, and a reflective surface on paper. Multiple grades of paper that have flexible structures, rigid paperboard, or rigid corrugated materials exist to provide strength characteristics for a package. Existing molded fiber and starch technologies are available to offer discrete 3-dimensional geometries, geometries with inner cavitation, and structural strength.

The methods and systems disclosed herein combine existing technologies for paper converting with existing manufacturing processes for molded fiber and starch. The devices, systems, and methods disclosed herein primarily apply to what is defined as Type 3 or Type 4 molded fiber by the International Molded Fiber Association. Type 1 and Type 2 molded fiber converting processes are not precluded. However, Type 1 and Type 2 generally require a secondary process be added for in mold drying with the method and system and, therefore, by definition would likely be referred to as Type 3 or Type 4.

The devices, systems, and methods disclosed herein are accomplished by creating a label or pre-form structure. These can be either two-dimensional flat or three-dimensional shaped, using existing converting technologies, then intimately combining the pre-form or label with the body of molded fiber or starch. The result is a new product with performance characteristics not delivered by the components individually.

The preform or label can be inserted into the tool for the molded fiber or starch by an automated arm. The label or preform can be held in place by vacuum, adhesive, hydro-static, gravity, electro-static, surface tension or other engineered force suitable to retain relative positioning between the label or preform and the tooling. The molded fiber or starch can be intimately pressed against the label in the drying process when the male and female tools are brought together under compression. One tool is typically heated for drying and the label is fused to the body of the molded fiber or starch. The fusion is created through time, temperature, pressure of compatible materials and can include adhesives. The end result is a body of molded fiber or starch intimately augmented to the preform or label presenting a unified package or container for commercial use.

The placement of the in mold label or preform can be on either the male tool or female tool. The placement relative to the fiber surface will determine if the feature is enhanced on the inside surface, or the outside surface of the finished part. Both of which can be desirable to augment the visual or mechanical properties for the component.

The method and systems defined within enable the creation of the following solutions for molded fiber and starch. The examples demonstrate enhanced functional performance while preserving sustainability attributes for use of natural, renewable raw materials and recyclable or compostable end of life.

Rigid molded fiber or starch containers/packages provided with:
(a) high-impact graphics for enhanced marketing communications, product safety, ingredient declarations, regulatory compliance, and use instructions;
(b) barrier properties to include, but not limited to, water, moisture, moisture vapor, grease, chemical resistance, oxygen, nitrogen or other gasses, UV light, and thermal barrier;
(c) modified surfaces to provide reflective characteristics. Such surface modifications can be used for functional characteristics or decorative; an example of functional enhancement might be for baking or heating of food; another example might be to reflect and redirect signals from an emitting device within the container or package;
(d) sealable surfaces to provide barrier, product containment, tamper evidence, or tamper resistance;
(e) absorbent properties such as required for holding meat or delivering solutions for incontinence;
(f) strength enhancements applied to discrete locations. Examples could include support for a flexible hinge, corner strength for compression or impact, lateral or transverse stiffness; and
(g) integrated electronic circuitry, electronic signal communications, electronically powered displays, or a surface treatment that is digitally machine readable.

Further, the methods and systems disclosed herein provide the ability for these functions/features (a)-(g) to be applied into discrete locations for the finished container/package, thus having different functional and visual characteristics in different locations on the finished container/package. A simplified example of this might be a frozen meal tray where it is beneficial for one location to have a reflective surface for crisping of a baked desert.

According to another aspect, a method for producing a molded fiber or starch product includes selecting a label or a preform having a first geometry. Next, an internal surface of a female tool may be modified by creating a recess which has a second geometry that matches the first geometry of the label or preform.

Subsequently, the label or preform can be placed accurately within the recess of the female tool. A male tool is then pressed into the female tool such that a fiber-starch material is sandwiched between the label or preform and the female tool in order to form the molded fiber or starch product with an augmented surface. Next, the molded fiber or starch product is cured such that the label or preform forms the augmented surface of the molded fiber product once cured.

According to another aspect, a method for producing a molded fiber or starch product includes selecting a label or a preform having a first geometry. Then, an external surface of a male tool is modified by creating a recess which has a second geometry that matches the first geometry of the label or preform.

Next, the label or preform is accurately placed within the recess of the male tool. The male tool is then pressed into a female tool such that a fiber-starch material is sandwiched between the label and male tool in order to form the molded fiber product with an augmented surface. Next, the molded fiber or starch product is cured such that the label or preform forms the augmented surface of the molded fiber product once cured.

The label or preform may include a plurality of layers. One of the layers can include paper, metal, and/or an adhesive. The fiber-starch material can be at least one of recyclable and biodegradable. The fiber-starch material may include any cellulose fibers made from at least one of virgin fibers, recycled paper, sugar-cane residues, corn stover, sugar beet residues, coconut husk including coir dust, cotton linters, citrus residues, sawdust, etc. and/or particulated fibers prepared from coagula or extruded fibers of water-insoluble biopolymers including calcium alginate, hemp, miscanthus, elephant grass, rice straw, wheat straw, bagasse, switch grass, or any other natural fiber.

Various implementations include a method for producing a molded fiber or starch product. The method includes obtaining a label or a preform having a first geometry; obtaining one of a male tool or a female tool, wherein a recess is defined in an external surface of the male tool or an internal surface of the female tool, wherein the recess has a second geometry that corresponds to the first geometry of the label or preform; disposing the label or preform within the recess of the one of the male tool or the female tool; obtaining another of the female tool or the male tool; pressing the male tool into the female tool such that a fiber-starch material is sandwiched between the label or preform and the other of the female tool or the male tool in order to form the molded fiber or starch product with the label or preform coupled to a surface of the molded fiber or starch product; and curing the molded fiber or starch product such that the label or preform forms an augmented surface of the molded fiber or starch product once cured.

Various other implementations include a package including a molded fiber or starch. The package has two or more surfaces. A label or a preform is at least partially recessed into and coupled to one of the two or more surfaces.

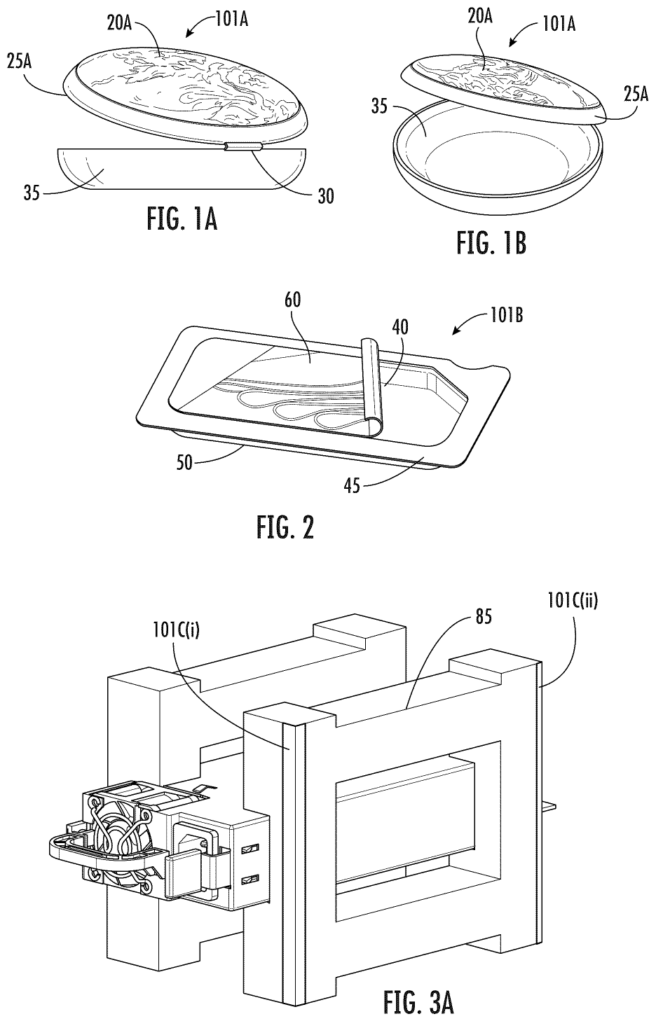

The products in FIGS. 1A-6 represent commercial use applications of the devices, systems, and methods disclosed herein. The drawings demonstrate how a molded fiber or starch container or package 101A may be commercially enhanced with high-impact graphics 20A applied to a surface thereof.

FIGS. 1A-1B show high-impact graphics that may comprise any number of images, alpha-numeric text, etc. In the exemplary embodiment illustrated in FIGS. 1A and 1B, the graphic 20A comprises a digital photograph of a cloud/gas formation. But as noted above, any number and/or combination of graphics, alpha-numeric text, and the like may form the graphic 20.

High resolution graphics 20A are often a critical component for a package to provide details such as use instructions, ingredients, claims, warnings, or technical-regulatory compliance. Additional examples of graphics placed onto bodies of molded fiber and starch are provided in 101F, and 101L. Current molded fiber and starch containers or packages lack the capability for these graphics, and therefor are primarily utilized for secondary or tertiary packaging solutions. By adding the element of high quality graphics/print, a container can now be utilized for primary packaging applications and offer a competitive alternative to non-sustainable plastics.

The container 101A of FIG. 1A may have a smooth, curved body surface formed of molded fiber or starch. However, other geometries/geometrical shapes are possible and are included within the scope of this disclosure. That is, the container 101A may take on both regular geometries as well as irregular and customized-sized shapes. For example, other geometries include, but are not limited to, regular polygons (i.e. square, rectangular, oval, elliptical, cylindrical, etc.) and irregular polygons (shapes with multiple corners, multiple curves, unique shapes that are unlike any defined/text-book regular geometries, etc.).

The container 101A may be made from natural/renewable materials of molded fiber or starch and are fully recyclable and/or compostable. FIG. 1A demonstrates an example of high impact graphics 20A applied to a smooth and domed structure 25A. The high impact graphics 20 transform the commercial value and functional ability for consumer use applications.

FIG. 1B illustrates a perspective view of the container 101A of FIG. 1A to demonstrate the smoothed, curved wall surface 35, domed profiles, and a hinge 30.

FIG. 2 provides an exemplary embodiment of a functional barrier enhancement for a container. In FIG. 2, it is demonstrated how a molded fiber or starch container 101B may be commercially enhanced to deliver a high-barrier. Current molded fiber solutions have limited barrier options, primarily providing a grease or water barrier, and often these barriers are achieved with the use of toxic “forever” chemicals such as PFAS and the family of fluorinated chemistries. FIG. 2 demonstrates how a barrier can be applied to the surface of molded pulp or starch through the use of an in-mold label or preform. FIG. 2 provides an example of how that surface can be made smooth to deliver a sealable interface for consumer access and to enable Modified Atmospheric Packaging (MAP) with molded fiber or starch.

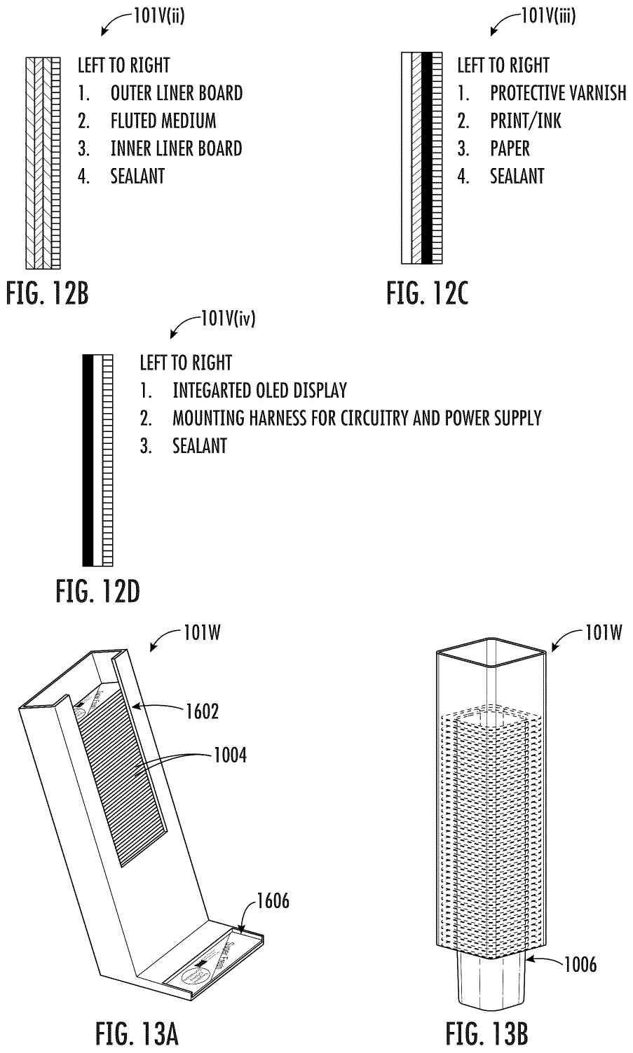

A lower body 40 of the container 101B in FIG. 2 is made from molded fiber or starch. In this example, a preform would be intimately adhered to the interior of the molded fiber or body 40. The preform is to be made from a natural/renewable and recyclable material, such as paper, with a barrier surface treatment applied. Any number of existing technologies can be utilized to create the barrier properties, to which one example might be the material structure described in FIG. 12A of 101V(i). As a preform, the surface profile contours can match that of the molded fiber body 40, and can include the flange 45, in this example.

A flange 45 is also illustrated in FIG. 2. The preform geometries can extend from the base of 40, up the side wall, and include the flange 45. The preform can have a sealable surface structure on the interior to which a lid stock 60 can be sealed to one side of the preform, where as the other side of the preform is intimately integrated with the body 40 of molded fiber and starch utilizing the method and processes disclosed herein. The smooth surface of the preform, on the flange 45 allows the lid stock 60 to have a cohesive bond and deliver a high barrier solution for the contents (not shown, i.e. food stuffs, like cold cuts illustrated with graphic) to include modified atmospheric packaging (MAP). Further, the smooth surface of the flange, 45, can provide a peel-seal feature for the body of molded fiber and starch 40.

The lower side panels and bottom of drawing 101B are indicated as feature 50. High impact graphics may be applied to an external surface of the molded fiber or starch container 101B using the technology described within. As an example, Feature 50 can be enhanced with graphics (not shown in FIG. 2); however other examples for reference would be illustrations 20A, 702, and 20B. In this exemplary embodiment, the graphics can be to the external side or bottom walls 50 of the container 101B. In this example illustrated in FIG. 2, the ability to apply high impact graphics to the molded fiber or starch container 101B can enable ingredients, regulatory disclosures, or machine readable codes applied to the surfaces of 101B.

FIG. 3A provides an exemplary embodiment of strength enhancements. FIG. 3A is a simplified drawing for a commercial use application of a structure 85 made of molded fiber or starch used for protective bracing. This is an example of an application that might be used as a sustainable replacement for existing products such as expanded plastic foam. FIG. 3A, demonstrates how a corner flange 101C may be applied in discrete locations as a surface modification for a molded fiber or starch body 85 to enhance mechanical strength or resiliency. The use of an in-mold label, or pre-form, engineered with enhanced strength properties can be precision placed into the molded part to augment and transform the operational performance of the molded part. An example, as presented in FIG. 3A, is the ability to enhance compression strength by re-enforcing corners of a molded fiber or starch body 85 with a label or preform applied to a corner flange 101C. Another iteration of this visual representation would be to engineer and enhance cushioning, or rebound properties, through the precision placement of an in-mold label or pre-form into discrete locations on a molded fiber or starch body.

FIGS. 3A-3B show corner flanges (made according to the methods described herein) being applied to a molded fiber or starch body 85 to augment the strength of the molded fiber or starch body 85. In this example, the augmented components 101C can enhance compression strength, cushioning, or rebound properties to improve performance for multiple impacts against a molded fiber or starch body 85 and thereby protect the contents of the package. The surface augmentation of a body of molded fiber or starch can provide protection for friction, scuffing or ware

FIG. 3B provides an exemplary embodiment of a strength enhancement demonstrated for discrete locations, and in this embodiment placed on a hinge 30. The use example and description is similar to those outlined for FIG. 3A, only in this application it is being demonstrated to enhance flexural strength for the hinge 30.

FIG. 3B shows precision placement of an in mold label 30 to reenforce the strength of a flexible joint or hinge thereby providing an extended use life for the container 101A. Another iteration of this visual representation would be to provide re-enforced properties for friction, or high wear locations.

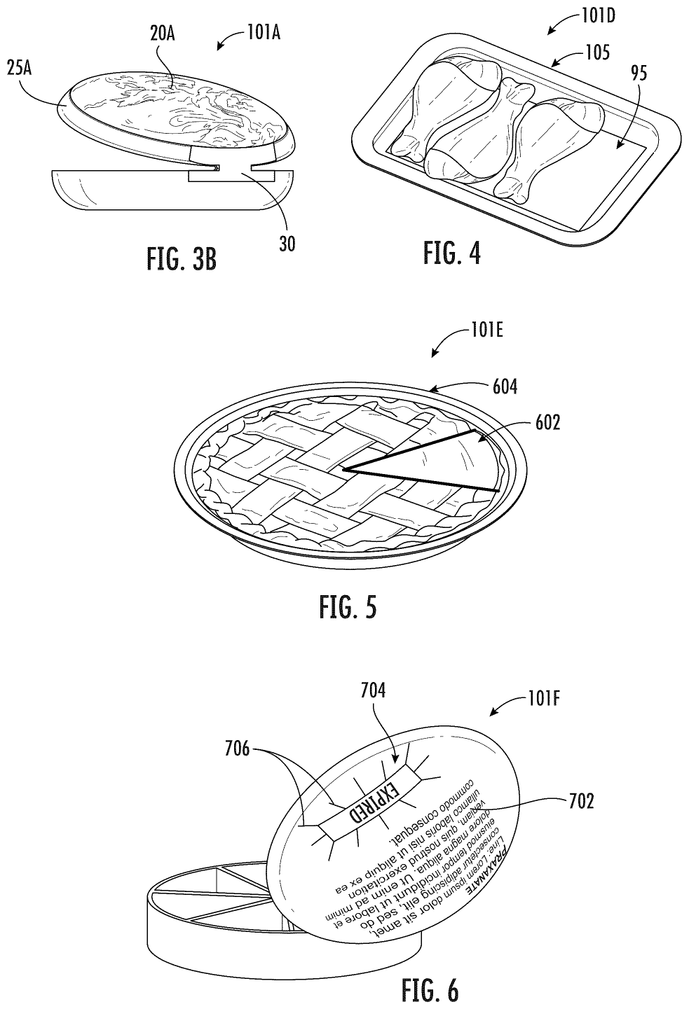

FIG. 4 provides an exemplary embodiment of a molded fiber or starch package or container that has a surface augmentation to deliver absorption properties in discrete locations. Commonly, molded fiber and starch do not have sufficient absorptive properties to accommodate the food stuff applications, such as meat or seafood. Traditional molded fiber or starch under these conditions would soften, weaken, degrade, or result in the product sitting in a puddle of fluids. The methods and systems disclosed herein provide the ability to intimately fuse a secondary component, in this case a natural, renewable, recyclable absorptive pad 95 to the body 105 of a molded fiber or starch. The end result is a system solution that delivers to the performance expectations for the demonstrated application. The body 105 of the tray can be made from a molded fiber or starch. An absorbent pad 95 can be integrated into the molded fiber or starch tray 105 to form a liquid absorbing system 101D. The absorbent pad 95 is assembled with the tray body 105 using the in-mold processes described herein.

FIG. 5 provides an exemplary embodiment of a container for food-stuffs made with a body 101E of molded fiber or starch whereas the surface has been modified using the methods disclosed herein to create metallized and reflective properties 602 on the top of the body 101E. FIG. 5 demonstrates food-stuff product removed from the package or container such that the base of the container can be shown 602 to feature the metallized surface.

The reflective surface 602 provides crisping for food-stuffs when they are placed in an oven. In this exemplary embodiment, the metallized surface 602 may be applied as a preform such that the surface has continuous reflective characteristics across the base of the package/container 101E, up the side walls of the container, and extending out on the top surface of the flange 604. The preform can be made from a material similar to the structure/layers illustrated in FIG. 12A (described below) and is capable of being produced on high speed and economically efficient converting machines.

The ability to modify the surface of molded fiber or starch to have reflective properties can generate additional commercial benefit for application beyond food containers. Using the methods and processes disclosed herein to modify the surface of molded fiber or starch to have reflective properties can be utilized to reflect, refract, concentrate, or otherwise redirect electronic signals or energy.

Reflective surfaces can also be utilized for controlling thermal properties, for example to assist in keeping contents cold and prevent thermal energy loss.

FIG. 6 provides an exemplary embodiment of molded fiber or starch that has a surface modification to incorporate electronic circuitry, power supply unit, or a digital display. A pharmaceutical product with a digital OLED or LED display 704 can be applied to the surface which is illuminating the word “Expired.” The display 704 has been provided with radial lines 706 to denote/demonstrate light rays to indicate the display can flash its alpha-numeric display 704 with different and/or varying light intensity as understood by one of ordinary skill in the art.

The display 704 may convey other messages besides “Expired” as understood by one of ordinary skill in the art. The electronic display 704 conveying the “Expired” text message may comprise an organic light-emitting diode (OLED) label that illuminates when the content(s) inside the package/container 101F has aged beyond its intended shelf-life. The exemplary embodiment of FIG. 6 provides the ability to integrate smart packaging components and features into the body 101F of molded fiber or starch. FIG. 6 provides further examples of a pharmaceutical package 101F made of molded fiber or starch and augmented with surface modifications using the methods disclosed herein to deliver high quality print and small fonts 702.

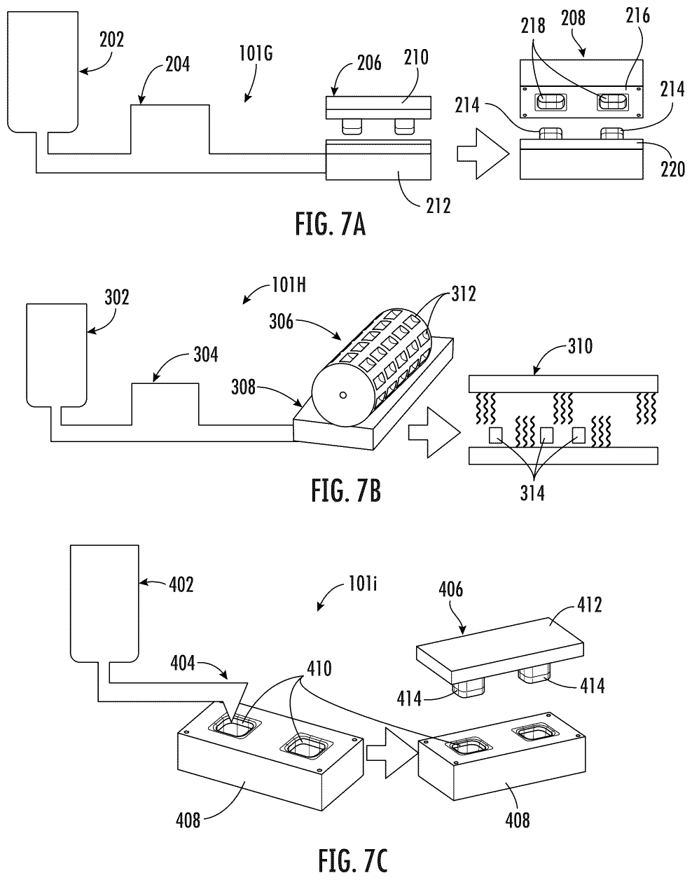

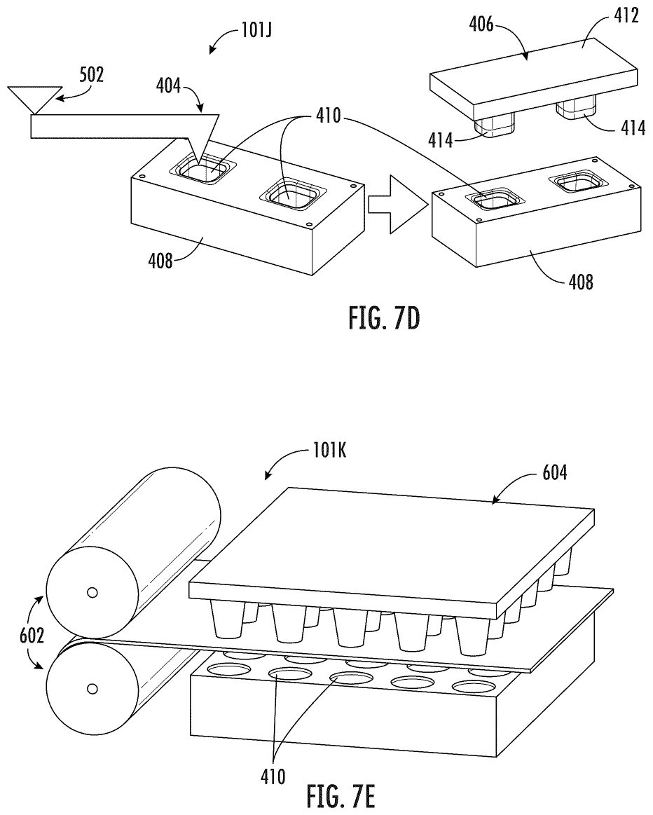

FIG. 7A provides an exemplary embodiment of a wet molded fiber, flat bed forming process that would be utilize to produce what is referred to in this innovation as the existing technologies used to create the “body of molded fiber or starch.” The key process sections demonstrated in FIG. 7A include the slurry 202, screening 204, wet forming, and then hot-press drying.

The first stage 202 of process 101G comprises a slurry tank filled with water, fibers, and chemistries ready for the molding process. The second stage 204 of the process 101G comprises filtering the fibers to screen the material and particle sizes. The third stage 206 illustrates a forming technique such as a mold press machine. In stage 206 the liquid fiber slurry suspended in feature 212 is presented to a male tool 210. The male tool 210 may be made from wire mesh, or a 3D printed structure forming a tooling screen 210. The tool 210 is submerged into the fiber slurry 212 and a vacuum is activated to pull the fluids with suspended fibers through the tooling. The fibers from the slurry are retained on the tool screen 210. In the fourth stage of the method 101G, this example provides a male tool with the fibers deposited on the tool. The male tool is then presented to a female tool 208. The female tool in this example is heated to dry and iron the fibers to finalize the formed package or container.

Other alternative exemplary embodiments of the manufacturing process 101G are possible where the mold tooling can be reversed. The use of the terms male tooling and female tooling in the processes described for 101G can be substituted to accommodate the specific features desired for the finished formed package or container. The manufacturing process 101G can be applied to any number of geometries, shapes, or structural designs and the shapes shown in the drawing provide an example of one embodiment.

FIG. 7B provides an exemplary embodiment of a wet molded fiber, rotary forming process that would be utilize to produce what is referred to in this innovation as the existing technologies used to create the “body of molded fiber or starch.” The key process sections demonstrated in FIG. 7B include the slurry 302, screening 304, wet forming, and then oven drying.

The process 101H referenced lacks sufficient capabilities as presented to incorporate the methods and features disclosed herein. To integrate the methods and features disclosed herein for manufacturing process 101H needs to be modified to include drying of the formed parts 314 in male/female tooling as depicted in FIG. 7A. The first stage 302 of process 101H comprises a slurry tank filled with water, fibers, and chemistries ready for the molding process. The second stage 304 of the process 101H comprises filtering the fibers to screen the material and particle sizes. The third stage 308 of the method 101H may include a bath of liquid fiber slurry where a rotary drum 306 having tooling 312 is partially submerged. The rotary drum 306 can have either a male or a female tooling 312. The tooling 312 may comprise wire mesh or 3D printed structures. A vacuum is commonly applied from a core of the drum 306 to pull the water and fiber slurry through the porous tools and depositing the fibers on the surface of each tool 312. The fourth stage shown as 310 commonly includes a drying process after the molded parts 314 are ejected from the tool 312 in the rotary drum 306. As noted above, this section 310 requires modification to accommodate the integration of the methods and features disclosed herein.

Other alternative exemplary embodiments of the manufacturing process 101H are possible where the mold tooling can be reversed. The use of the terms male tooling and female tooling in the processes described for 101H can be substituted to accommodate the specific features desired for the finished formed package or container. The manufacturing process 101H can be applied to any number of geometries, shapes, or structural designs and the shapes shown in the drawing provide an example of one embodiment.

FIG. 7C provides an exemplary embodiment 101i of a baked molded fiber/starch process in a flat bed forming process. Process 101k corresponds with U.S. Patent US7700172B2, which is incorporated by reference. Illustration 101i depicts a process that would be utilize to produce what is referred to in this innovation as the existing technologies to create the “body of molded fiber or starch”. The key process sections demonstrated in FIG. 7C include the blending of a fiber and starch into a dough 402, the metering of the fiber and starch 404, and then hot-press forming and drying. Step 402 illustrates the blending of a fiber and starch mix. Step 404 illustrates the metering, cutting, and depositing the fiber and starch ‘dough’ into discrete molds. Step 410 illustrates the female tooling receiving the fiber starch dough. A press 406 has a male tool 414 being presented to and compressing onto the female tool 410 such the starch ‘dough’ is formed into the discrete part geometry. The male tool 414 and female tool 410 are commonly heated to solidify the fiber and starch ‘dough’ into the discrete part geometry.

Other alternative exemplary embodiments of the manufacturing process 101i are possible where the mold tooling can be reversed. The use of the terms male tooling and female tooling in the processes described for 101i can be substituted to accommodate the specific features desired for the finished formed package or container. The manufacturing process 101i can be applied to any number of geometries, shapes, or structural designs and the shapes shown in the drawing provide an example of one embodiment.

FIG. 7D provides an exemplary embodiment of a baked molded fiber/starch process with flatbed forming that would be utilized to produce what is referred to in this innovation as the existing technologies to create the “body of molded fiber or starch.” The key processes demonstrated include the blending of a fiber/starch 502, the extrusion of the fiber/starch 404, and then hot-press forming and drying. Illustration 101J is similar to FIG. 7C, however, the fiber/starch material is processed in an extruder. The process 101J corresponds with U.S. Pat. No. 7,700,172, which is incorporated by reference.

The first stage 502 illustrates the fiber and starch being blended. The second stage 404 illustrates the fiber and starch being extruded. Step 410 illustrates the female tooling receiving the fiber starch dough. Step 406 is a press which has a holding block 412 that supports male tools 414 being presented to and compressing onto the female tool 410 such the starch ‘dough’ is formed into the discrete part geometry. The male tool 414 and female tool 410 are commonly heated to solidify the fiber and starch ‘dough’ into the discrete part geometry.

FIG. 7E provides an exemplary embodiment of a dry molded fiber/starch process with flatbed forming that would be utilize to produce what is referred to in this innovation as the existing technologies to create the “body of molded fiber or starch.” The key process sections demonstrated in Illustration 101K include the unwind and pre-conditioning section for the roll stock of fiber fluff pulp or papers 602, and then the 3D forming of the fibers, commonly under heat and pressure. The process 101K corresponds with U.S. Patent Application Publications US20220234258A1, US20230321878A1, US20230321866A1, US20230356494A1, US20220251785A1, and US20240009950A1, the entire contents of each patent is hereby incorporated by reference. Illustration 602 of process 101k demonstrate a web of fluff pulp 602 that is shredded and created inside the machine. The web of fluff pulp 602 is often pressed with other layers of materials prior to entering the forming tooling. The male tool 604 is pressed together with the female tool 606 while the fiber web of 602 is presented between the tools. The 3D formed geometry is created with pressure, heat, and time.

Other alternative exemplary embodiments of the manufacturing process 101K are possible where the mold tooling can be reversed. The use of the terms male tooling and female tooling in the processes described for 101k can be substituted to accommodate the specific features desired for the finished formed package or container. The manufacturing process 101k can be applied to any number of geometries, shapes, or structural designs and the shapes shown in the drawing provide an example of one embodiment.

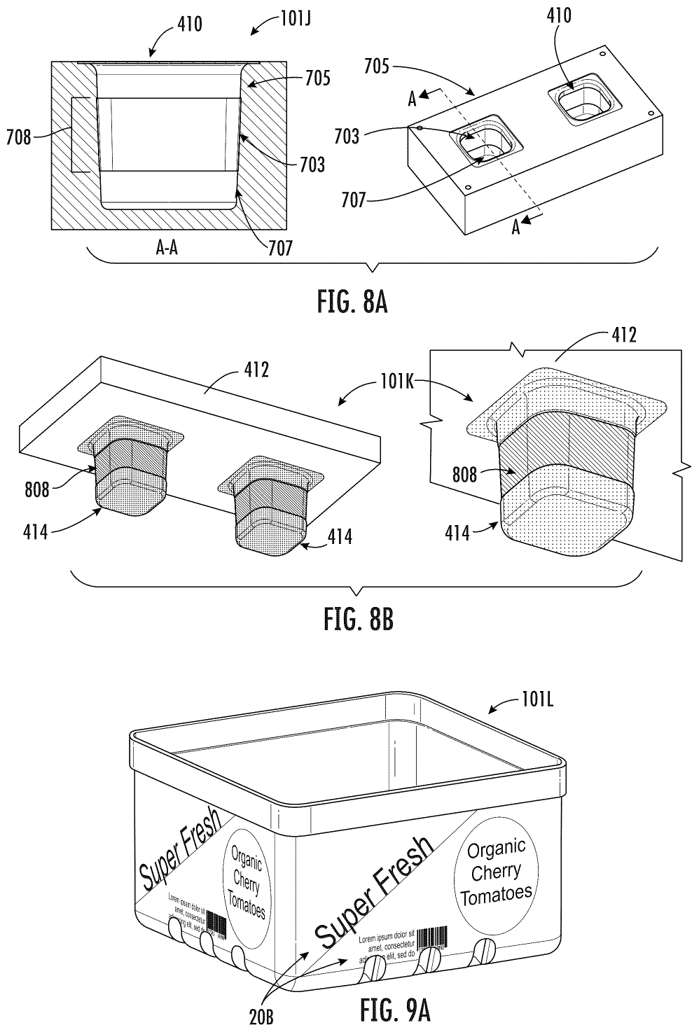

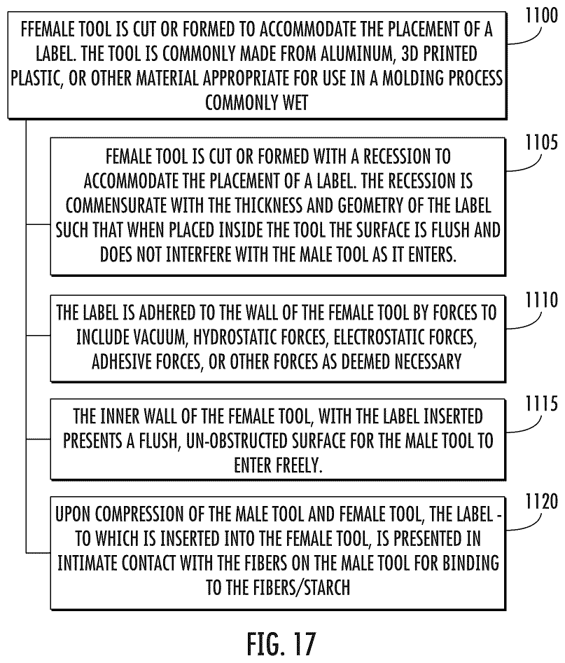

FIG. 8A shows an exemplary embodiment of a female tool 705. A cross-sectional view (left side-section A-A) is provided, as well as a perspective view (right side). Illustration 101J is a focused look at a female tool 705 that is referenced in the drying processes shown in FIGS. 7A and 7C-7E. Illustration 101J provides descriptive details on the placement and use of an in mold label into a female tool. Illustration 101J is further described in process flowchart FIG. 17.

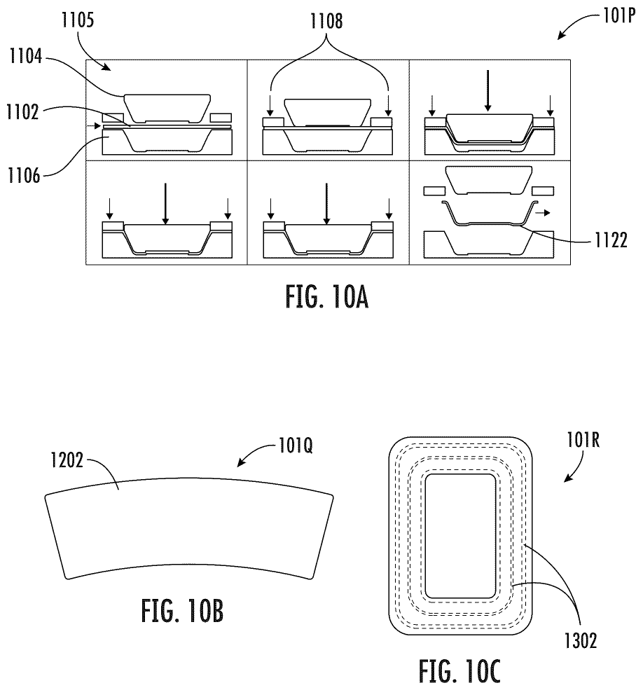

A female tool 705, with a panel 703 is modified to accommodate the male tool. The panel 703 of female tool/mold 705 has dimensionally been altered such that an in mold label 1202 (not visible in FIG. 8A but see FIG. 10B) can be placed inside the female tool 705, and placed inside the recession/recess 703, such that the label 1202 will present a flush surface for the inner wall of the female tool 707. The shaded image of 708 provides a representation of the label placed inside the female tool 705.

Once the label is placed into the female tool 705 it is held into position by vacuum, by hydrostatic forces, by electrostatic forces, by adhesive forces, or other forces as deemed necessary to retain the part contained in the recession of 703 and flush to the wall of 707 such that it does not obstruct movement between the female tool 705 and the male tool (not shown).

As referenced in processes shown in FIGS. 7A and 7C-7E, the female tool 705 closes into intimate contact with the male tool (not shown). The fibers and the in-mold label are then presented in intimate contact under pressure and heat. The compressive pressure along with the vacuum, commonly in the male tool, will extract water. The heat and pressure from the female tool 705 will iron the surface. The combination of this heat, pressure, and vacuum along with the intimate surface connection of the label with the fibers creates the surface interface for adhesion between the components. This bonding can be further enhanced with the use of adhesives as needed applied to the surface of the label.

In some instances, it may be desirable to intentionally engineer the profile geometries between the tool and label such that there are intentional gaps between the body and the label. Such intentional gaps could be beneficial for mechanical characteristics of the finished component, one example of which might be for thermal barrier.

FIG. 17 process steps 1100 through 1120 provide further details on the tooling preparation for receiving the in mold label. In FIG. 17 process step 1100, the female tool is commonly made from aluminum, 3D printed plastics, or other materials as appropriate for use in a molding process commonly wet. The cutting of the tool is commonly done in a CAD/CAM machine using an extractive process. Alternative approach is to construct tooling using an additive process such as 3D printing.

FIG. 17 process step 1105 shows using the construction methods described in FIG. 17, step 1100, the panel to accommodate the label is created with the geometric profile of the label to include accommodation for the thickness of the label. The panel for holding the label shall have an edge profile that supports the label being retained into position in the female tool.

In FIG. 17 process step 1110, when the label is placed into the female tool, it is held in place by any number of different forces to include hydrostatic, electrostatic, vacuum, adhesive forces, or through the geometric profiling of the tool such that one or more edge of the label rests on the tool. In FIG. 17 process step 1120, once the label is added to the female tool, the male tool will then enter the female tool and the label will be presented in contact with the fibers which are adhered to the male tool. The manufacturing process 101J can be applied to any number of geometries, shapes, or structural designs and the shapes shown in the drawing provide an example of one embodiment.

The objective of the devices, systems, and methods disclosed herein is to modify or augment a surface of the finished part. The processes within this disclosure describe how to augment a male tool, and a female tool with a label or a preform. It is the intimate relationship of the label or preform to the fibers or starch that can be interchangeable based on the expressed design intent of the use applications.

For example, a label can be placed on a male tool, the fibers can be deposited on the female tool. The male tool, with label converges with the female tool. The label is adhered to the fibers on the female tool. The result is the inner surface of the finished part being modified or augmented.

In a similar example, the fibers can be placed on a male tool first, the label can be placed on the male tool on top of the fibers, the male tool with label can be presented to the female tool. The augmented surface is now on the exterior of the finished product.

In another example, a label can be placed into the female tool, the fibers deposited on the male tool, the male tool converges on the female tool, and the augmented surface is the exterior of the product.

The above examples demonstrate how the product designer can utilize the devices, systems, and methods disclosed herein within to modify or augment either the inner or exterior surfaces of molded fiber or starch.

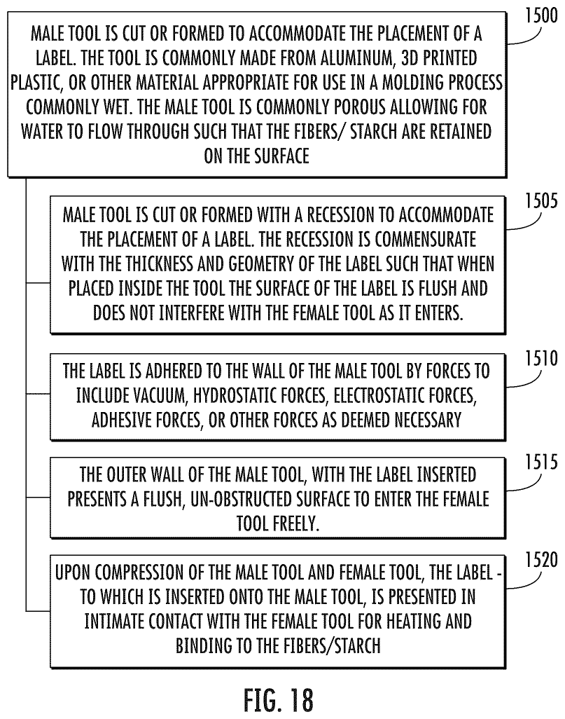

Referring now to FIG. 8B, reference number 101k shows an exemplary embodiment of a male tool 414 that is referenced in the manufacturing processes shown in FIGS. 7A-7E. Illustration 101k seeks to provide descriptive details on the placement and use of an in mold label onto a male tool. Illustration 101K is further described in process flowchart FIG. 18.

A male tool 414 is shown with a panel 808 modified to accommodate the female tool. A recess 808 and a section of the male tool 414 that is dimensionally altered such that an in mold label 1202 (not visible in FIG. 8B but see FIG. 10B) can be placed on the male tool 414, and placed inside the recession/recess 808, such that the label 1202 (not visible in FIG. 8B but see FIG. 10B), will present a flush surface for the of the male tool 414.

Once the label is placed onto the male tool 414 it is held into position by vacuum, by hydrostatic forces, by electrostatic forces, by adhesive forces, or other forces as deemed necessary to retain the part contained in the recession of 808 and flush to the wall of 414 such that it does not obstruct movement when the male tool 414 is compressed into the female tool 705 (not shown).

As referenced in processes 7A-7E, the male tool 414 closes into intimate contact with the female tool (not shown). The fibers and the in mold label are then presented in intimate contact under pressure and heat. The compressive pressure along with the vacuum, commonly in the male tool, will extract water. The heat and pressure from the female tool (not shown) will iron the surface. The combination of this heat, pressure, and vacuum along with the intimate surface connection of the label with the fibers creates the surface interface for adhesion between the components. This bonding can be further enhanced with the use of adhesives as needed applied to the surface of the label.

In some instances, it may be desirable to intentionally engineer the profile geometries between the tool and label such that there are intentional gaps between the body and the label. Such intentional gaps could be beneficial for mechanical characteristics of the finished component, one example of which might be for thermal barrier.

Process steps 1500 through 1520 provide further details on the tooling preparation for receiving the in mold label. FIG. 18 step 1500 shows a male tool commonly made from aluminum, 3D printed plastics, or other materials as appropriate for use in a molding process commonly wet. The male tool is commonly porous and can be made from a wire mesh, or 3D printed with internal channels for flowing of fluids. When wire mesh is used, the tool is formed to the desired geometric profile through bending or pressing. Step 1505 of FIG. 18 shows using the construction methods described in FIG. 18, 1500, the panel to accommodate the label is created with the geometric profile of the label to include accommodation for the thickness of the label. The panel for holding the label shall have an edge profile that supports the label being retained into position in the male tool.

In FIG. 18 step 1510, when the label is placed into the male tool, it is held in place by any number of different forces to include hydrostatic, electrostatic, vacuum, adhesive forces, or through the geometric profiling of the tool such that one or more edge of the label rests on the tool.

In FIG. 18 steps 1515 and 1520, once the label is added to the male tool, the male tool will then enter the female tool and the label will be presented in contact with the heated surface of the female tool for drying.

The manufacturing process 101K can be applied to any number of geometries, shapes, or structural designs and the shapes shown in the drawing provide an example of one embodiment.

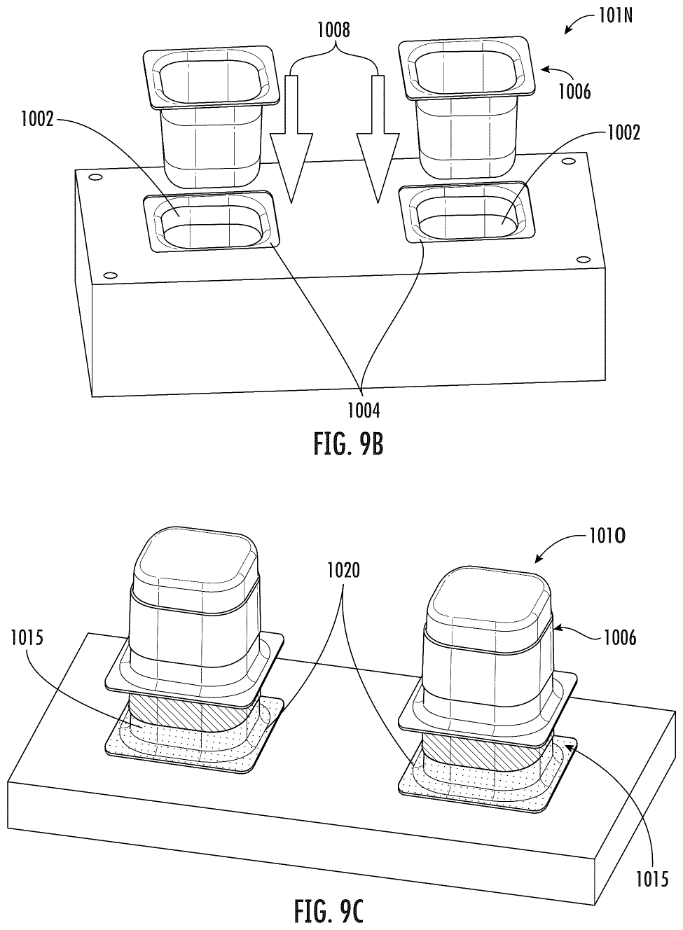

FIG. 9A shows an exemplary embodiment of a finished product utilizing a flat in mold label 20B integrated into a body of molded fiber or starch 101L. The in-mold label 20B is applied to the exterior panels for the purpose of providing enhanced graphics. The label 20B is fused to the body 101L and is presented flush to the surface of the container 101L. The label 20B may be made of a natural, renewable paper with a material composition similar to that described in connection with FIG. 12A-12D. The material composition for container 101L is designed for certified recyclable or compostable, therefor as integrated with the body of molded fiber or starch, the entire package system 101L is designed for certified compostable or recyclable. The in mold label may comprise machine-readable codes, such as, but not limited to, a scannable bar code; as well as human-readable alpha-numeric text which may include small fonts, and an array of colors.

The illustration 101L can be applied to any number of geometries, shapes, or structural designs and the shapes shown in the drawing provide an example of one embodiment.

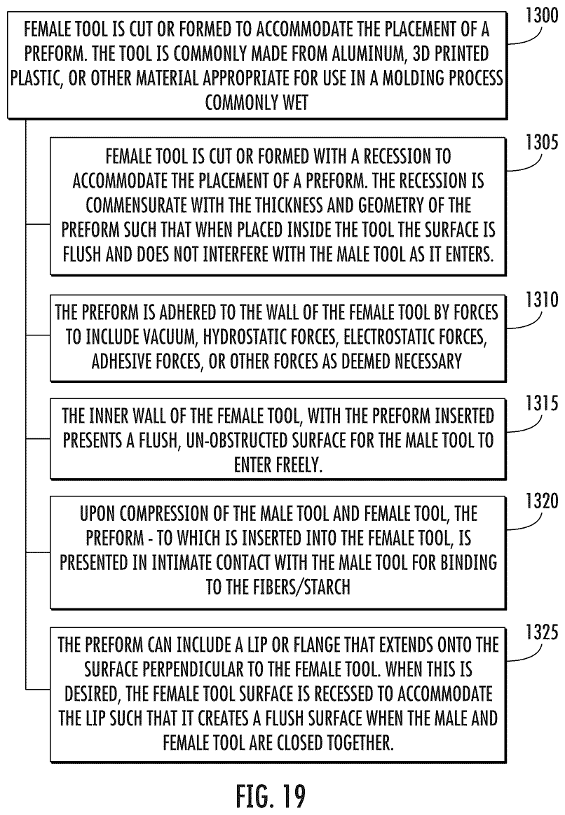

Illustration 101N shown in FIG. 9B demonstrates an exemplary embodiment of female tool 1002 with a preform 1006 being inserted (motion 1008) into a female tool 1002. A female tool 1002 is manufactured with an over-sized geometry to accommodate a preform such that when the preform 1006 is inserted (arrows 1008) into the female tool 1002, the male tool (not shown), can freely move in relation to the female tool when compressed together. The process is further described in FIG. 19.

The rectangular lines 1004 represent how the top surface of the female tool is adjusted to match the thickness of the preform 1006 such that when the female tool is brought into a compressive relationship with the male tool, the top surface shown 1004 with the preform 1006 inserted into the female tool 1002 produces a flush surface.

The preform 1006 can be geometrically formed to match the wall contours of the female tool 1002 as desired. Matching of the contours provides a smooth and seamless surface on the finished part with the preform intimately fused to the body of molded fiber or starch.

In some instances, it may be desirable to intentionally engineer the profile geometries between the tool and preform such that there are intentional gaps between the body and the preform. Such intentional gaps could be beneficial for mechanical characteristics of the finished component, one example of which might be for thermal barrier.

FIG. 19 processes 1300-1325 further describe the augmentation of a female tool for a preform. Step 1300 shows a female tool that is commonly made from aluminum, 3D printed plastics, or other materials as appropriate for use in a molding process commonly wet.

Step 1305 of FIG. 19 shows using the construction methods described in FIG. 19, 1300, the panel to accommodate the preform is created with the geometric profile of the preform to include accommodation for the thickness of the preform. The panel for holding the preform shall have an edge profile that supports the preform being retained into position in the female tool.

In FIG. 19 step 1310, when the preform is placed into the female tool, it is commonly held in place by gravity, although any number of different forces to include hydrostatic, electrostatic, vacuum, adhesive forces, or through the geometric profiling of the tool such that one or more edge of the label rests on the tool.

In FIG. 19 steps 1315, 1320, and 1325, once the preform is added to the female tool, the male tool will then enter the female tool and the preform will be presented in contact with the fibers that are attached to the surface of the male tool.

The illustration 101N can be applied to any number of geometries, shapes, or structural designs and the shapes shown in the drawing provide an example of one embodiment.

Illustration 101O of FIG. 9C demonstrates an exemplary embodiment of male tool 1015 with a preform 1006 being inserted onto a male tool 1015. The preform 1006 is shown with a matched profile geometry to align with the male tool 1015.

The male tool 1015 is manufactured with an undersized geometry such that when the preform 1006 is placed over the male tool, the combined male tool 1015 and preform 1006 provide an intimate fit with the female tool (not shown), such that the male and female tool may move freely and into compressive conditions without obstructing the path of movement.

The shaded area and lines 1020 represent how the top surface of the male tool is adjusted to match the thickness of the preform 1006 such that when the female tool is brought into a compressive relationship with the male tool, the top surface shown 1020 with the preform 1006 inserted produces a flush surface.

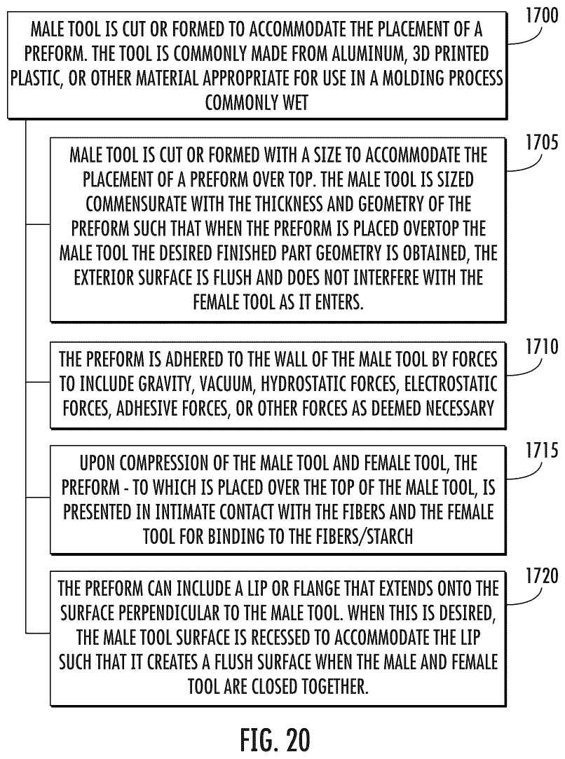

FIG. 20 process 1700-1720 further describes the augmentation of a male tool for a preform. Step 1700 of FIG. 20 shows a male tool is commonly made from aluminum, 3D printed plastics, or other materials as appropriate for use in a molding process commonly wet. The male tool is commonly porous and can be made from a wire mesh, or 3D printed with internal channels for flowing of fluids. When wire mesh is used, the tool is formed to the desired geometric profile through bending or pressing.

Step 1705 of FIG. 20 shows using the construction methods described in FIG. 20, 1700, the panel to accommodate the preform is created with the geometric profile of the preform to include accommodation for the thickness of the preform. The panel for holding the preform shall have an edge profile that supports the label being retained into position in the male tool.

In FIG. 20 step 1710, when the preform is placed onto the male tool, it is held in place by any number of different forces to include gravity, hydrostatic, electrostatic, vacuum, adhesive forces, or through the geometric profiling of the tool such that one or more edge of the label rests on the tool.

In FIG. 20 steps 1715 and 1720, once the preform is added to the male tool, the male tool will then enter the female tool and the preform will be presented in contact with the fibers and the heated surface of the female tool for drying.

The illustration 101O can be applied to any number of geometries, shapes, or structural designs and the shapes shown in the drawing provide an example of one embodiment.

Illustration 101P of FIG. 10A demonstrates an exemplary embodiment of a process commonly used to produce a preform. The process demonstrated in 101P is commonly referred to as press forming.

Step 1 illustrates a flat sheet, blank, or web 1102 of material entering the process. The material 1102 is positioned with the male tool 1104 on one side and a female tool 1006 on the other side. 1102 is pre-constructed using processing technologies covered in FIGS. 12A-12D. The web or sheet 1102 of material is commonly pre-scored or cut into blanks according to the design process outlined in section 8. An exemplary embodiment of a cut and score pattern for a common tray is provided in FIG. 10C, illustration 101R.

Step 2 illustrates the material 1102 being clamped along the perimeter (1108). The tools, 1104 and 1106, converge on the material 1102 in a sequenced motion timed with the clamping force on the perimeter to form the flat web into a 3D geometry. The clamp force of 1108 is precision controlled while the male tool 1104 and female tool 1106 converge such that the clamp force 1108 is increased or decreased to enable the material 1102 to slip in a controlled manner.

Step 6 illustrates the finished product, a 3D formed part 1122.

The illustration 101P can be applied to any number of geometries, shapes, or structural designs and the shapes shown in the drawing provide an example of one embodiment.

Alternatives for the production of a preform can include folding and gluing technologies. Such technologies enable the use of existing, high-speed converting to create a preform.

Illustration 101Q of FIG. 10B demonstrates an exemplary embodiment of an in-mold label presented as a flat structure 1202. The flat configuration/structure 1202 enables the structure 1202 to be manufactured on existing, high-speed converting processes for economic efficiencies and quality. Many existing converting technologies can be utilized, to include but not limited paper making, laminating, printing, coating, metallizing, 3D printing, extruding, blowing, die cutting, laser cutting, etc.

The material composition for the in mold label 1202 can be any material that satisfies the functional and sustainability requirements for the finished product. Examples of materials are provided in FIG. 12A-12D. The illustration 1202 can be an example of a label die line that would be appropriate for use on a round container as an in-mold label

The illustration 101Q can be applied to any number of geometries, shapes, or structural designs and the shapes shown in the drawing provide an example of one embodiment.

Illustration 101R of FIG. 10C demonstrates an exemplary embodiment of a preform presented as a flat structure 101R. The flat configuration of 101R enables the structure to be manufactured on existing, high-speed converting processes for economic efficiencies and quality. Many existing converting technologies can be utilized, to include but not limited paper making, laminating, printing, coating, metallizing, 3D printing, extruding, blowing, die cutting, laser cutting, etc.

The material composition for the preform 101R can be any material that satisfies the functional and sustainability requirements for the finished product. Examples of materials are provided in FIGS. 12A-12D. The illustration 101R can be an example of a preform that would be appropriate for use as a tray. The dashed lines 1302 demonstrates an exemplary embodiment of score patterns that can be applied to the material before being preformed. The score lines assist in achieving the desired 3D geometry.

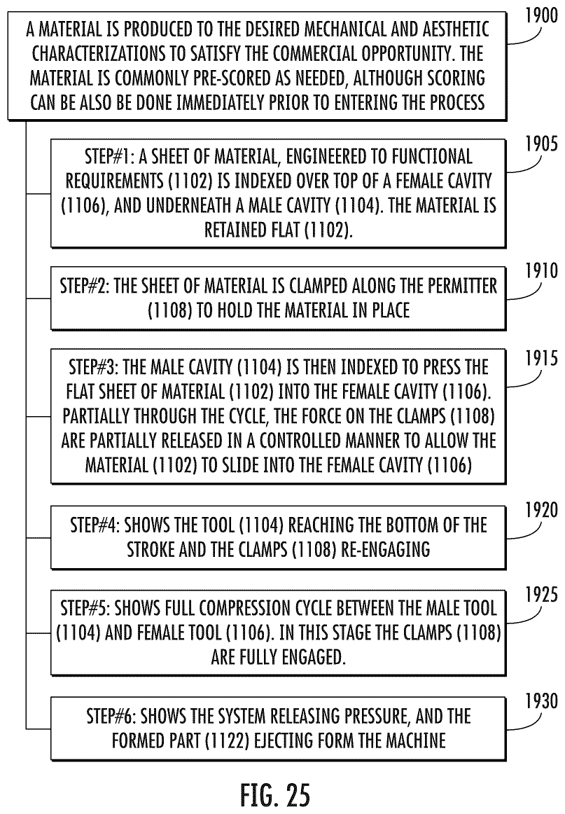

FIG. 25 process 1900-1930 further describe the making of a preform. The illustration 101R can be applied to any number of geometries, shapes, or structural designs and the shapes shown in the drawing provide an example of one embodiment.

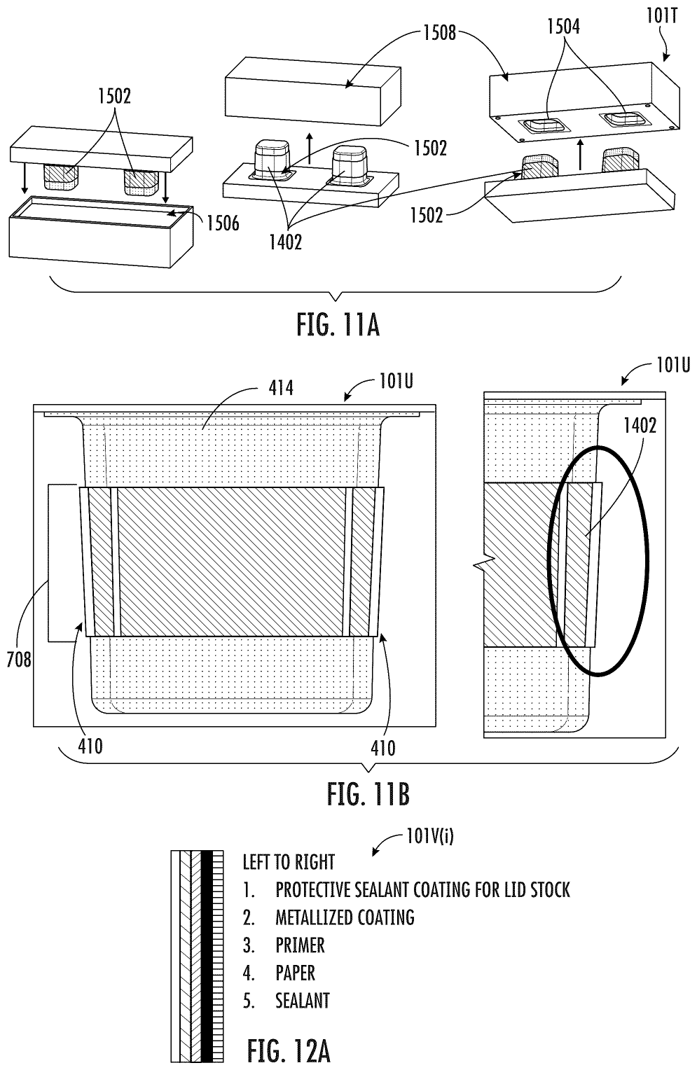

Illustration 101T of FIG. 11A provides an exemplary embodiment of wet molded fiber, flat bed tooling where the male tool is being used to form body of molded fiber or starch. The male tooling 1502 is commonly made from aluminum, 3D printed plastic, or other material appropriate for use in a molding process commonly wet. The male tool is commonly porous to allow fluids to pass through. In this embodiment, the male tool 1502 is submerged, or partially submerged into an aqueous slurry 1506 containing suspended fiber or starch as further described in processes 7A-7B. A vacuum is pulled from inside the male tool 1502. The fluids of the liquid slurry bath 1506 pass through the porous tools 1502, and the fibers are retained on the surface of each tool 1502.

In Option 1, the male tool 1502 can be modified to accommodate the methods and features disclosed herein. The modification can be made to accommodate the application of an in mold label or a preform. Any one of the options below can be utilized to achieve desired outcomes. The male tool 1502 can be modified to accommodate a label as detailed in FIG. 8B, and FIG. 18. The male tool 1502 can be modified to accommodate a preform as detailed in FIG. 9C and FIG. 20.

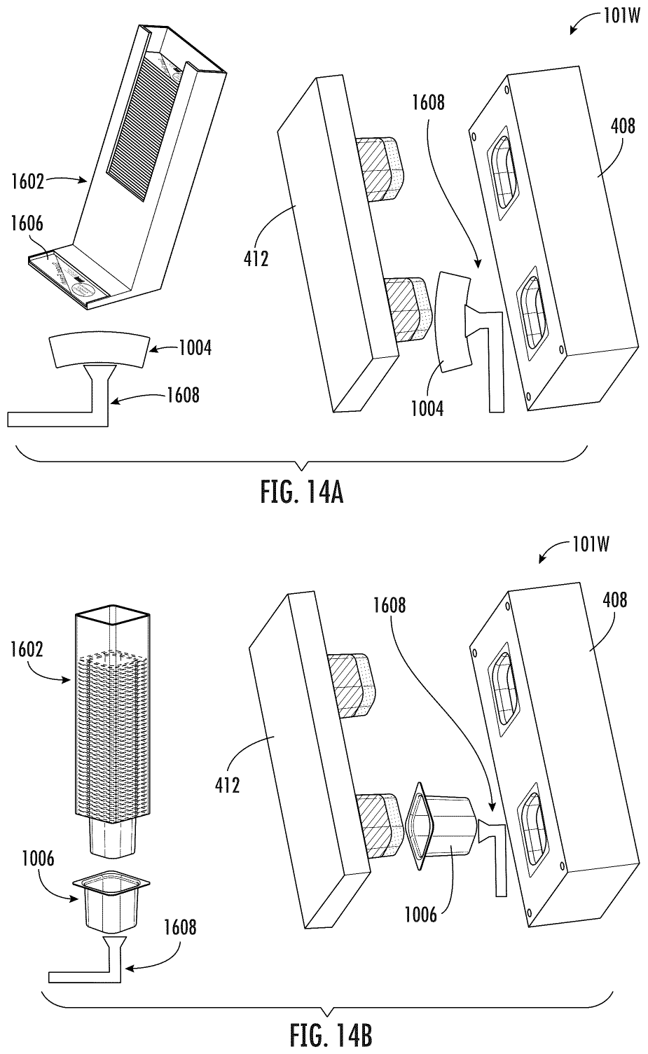

In Option 2, the female tool 1504 can be modified to accommodate the innovation within. The modification can be made to accommodate the application of an in mold label preform. Any one of the options below can be utilized to achieve desired outcomes. The female tool 1504 can be modified to accommodate a label as detailed in FIG. 8A, and FIG. 17. The female tool 1504 can be modified to accommodate a preform as detailed in FIG. 9B and FIG. 19. The male tool 1502 being presented to a heated female tool 1504 for drying and ironing of the surface. At this stage the sub-systems described in FIGS. 14A-14B will apply the label or preform to the male tool 1502 or female tool 1504. Each male tool 1502 is now ready to be presented to a respective female tool 1504. The heated mold 1508 provides for drying and ironing the fibers on the male tool 1502. The last visual illustrates the male tool 1502 tipped at an angle (a perspective view) to better illustrate the female tools 1504.

Illustration 101U of FIG. 11B provides an exemplary embodiment of a male tool 414 inside the female tool 410. 1402 represents an example of an in mold label. In this instance, the label 1402 is integrated into the female tool 410. 410 and the expressed area featured with a circle on the right detailed view shows the interface of the female tool 410 with label 1402 set into the female tool 410 such that it presents an unobstructed pathway for the male tool 414 to enter the female tool 410 without obstruction. The label or preform 1402 can be held in position by vacuum, hydrostatic surface tension, electrostatic surface tension, or adhesives The label 1402 is in intimate contact with the molded fibers or starch adhered to the surface of male tool 414.

Referring now to FIG. 12A, illustration 101V(i) provides an exemplary embodiment of one material composition that can be commonly used to produce an in mold label or preform. Many material compositions are possible and compatible with the innovation. The material composition will be discretely designed to meet the functional, operational, consumer, and, sustainability requirements for a given application. The exemplary embodiments of materials expressed in FIGS. 12A-12D are existing technologies and capable of being produced on high speed and economically efficient converting processes.

FIG. 12A demonstrates one embodiment that might be used to deliver a barrier solution. The base material demonstrated here is a paper, layer 4. This embodiment is provided to demonstrate a natural, renewable, and recyclable substrate. Layer 2 is shown to be a metallized surface. This embodiment is shown to demonstrate a barrier layer that is recyclable. Current metallize coating technologies can deliver moisture vapor barrier as much as 1 g/m2/day in 38c/90% RH conditions. Layers 1, 3, and 5 can include a multitude of materials, tie-layers, or adhesive layers that can be utilized to bind, to surface treat, or to otherwise make the adjacent materials comparable or confirmative to the desired manufacturing process requirements. As one example, PVOH coatings are recyclable and can provide oxygen permeation barrier as much as 0.1 cm3/m2/day in 20c/65% RH conditions.

Referring now to FIG. 12B, illustration 101V(ii) provides an exemplary embodiment of one material composition that can be commonly used to produce an in mold label or preform. Many material compositions are possible and compatible with the innovation. The material composition will be discretely designed to meet the functional, operational, consumer, and, sustainability requirements for a given application. The exemplary embodiments of materials expressed in FIGS. 12A-12D are existing technologies and capable of being produced on high speed and economically efficient converting processes. FIG. 12B demonstrates one embodiment that might be used to deliver enhanced strength. The base material demonstrated here is a fluted material, layer 4. This embodiment is provided to demonstrate a natural, renewable, and recyclable substrate that would demonstrate enhanced strength. Layers 4 demonstrates the opportunity to include adhesive characteristics to bind the material to another surface.

Referring now to FIG. 12C, illustration 101V(iii) provides an exemplary embodiment of one material composition that can be commonly used to produce an in mold label or preform. Many material compositions are possible and compatible with the innovation. The material composition will be discretely designed to meet the functional, operational, consumer, and, sustainability requirements for a given application. The exemplary embodiments of materials expressed in FIGS. 12A-12D are existing technologies and capable of being produced on high speed and economically efficient converting processes. FIG. 12C demonstrates one embodiment that might be used to deliver high impact printed graphics. The base material demonstrated here is a paper, layer 2. This embodiment is provided to demonstrate a natural, renewable, and recyclable substrate that would be appropriate for the art of printed graphics, text, or numerical values. Layer 4 demonstrates the opportunity to include adhesive characteristics to bind the material to another surface.

Referring now to FIG. 12D, illustration 101V(iv) provides an exemplary embodiment of one material composition that can be used to produce an in mold label or preform. Many material compositions are possible and compatible with the innovation. The material composition will be discretely designed to meet the functional, operational, consumer, and, sustainability requirements for a given application. The exemplary embodiments of materials expressed in FIGS. 12A-12D are existing technologies and capable of being produced on high speed and economically efficient converting processes. FIG. 12D demonstrates one embodiment that might be used to deliver integrated electronic displays for conveying alpha-numeric text messages to consumers. Layer 1 demonstrates an OLED display. The base material demonstrated here is a mounting harness integrated with circuitry and power supply. Layer 3 demonstrates the opportunity to include adhesive characteristics to bind the material to another surface.

Referring now to FIG. 13A, illustration 101W provides an exemplary embodiment of a flat label organized in a manner to enable the mechanized retrieval of a single label with a consistent orientation. Multiple existing technologies can be utilized to deliver a flat label to the automated processes detailed in FIG. 14A and within. A magazine stack 1602 shows pre-cut flat labels 1004 organized in a manner suitable for consistency in positioning and orientation. The label 1004 is presented as a singularity for a robotic arm (not shown) to discretely pick an individual label 1004 for placement into either the male or female tooling as detailed within. The illustration 101w is one exemplary embodiment. Many alternate configurations are available to include horizontal, vertical, angular, bottom up, top down, or rotary to name a few. The illustration 101w is one exemplary embodiment. Illustration 101w shows pre-cut labels 1004. Alternative embodiments can include delivery of labels on a rotary web or roll.

Referring now to FIG. 13B, illustration 101W provides an exemplary embodiment of preforms organized in a manner to enable the mechanized retrieval of a single preform with a consistent orientation. Multiple existing technologies can be utilized to deliver a preform to the automated processes detailed in FIG. 14B and within. Illustration 101W shows a magazine stack 1602 for Pre-Forms 1006. FIG. 13B is similar to that of FIG. 13A, and is modified to feature the use of a pre-form 1006 instead of a label 1004. The preform 1006 is presented as a singularity for a robotic arm (not shown) to discretely pick an individual preform 1006 for placement into either the male or female tooling as detailed within. The illustration 101w is one exemplary embodiment. Many alternate configurations are available to include horizontal, vertical, angular, bottom up, top down, or rotary to name a few.

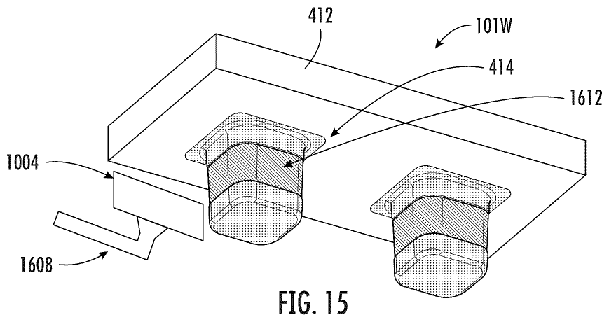

Referring now to FIG. 14A, illustration 101W provides an exemplary embodiment of the systems utilized for the placement of a discrete in mold label 1004 into a male tool 414 or female tool 408. Illustration 1602 and 1606 detail the processes described in FIG. 13A. Illustrations 1004 and 1608 depict a single label 1004 being picked from system FIG. 13A and held by the robotic arm 1608. The labels may be picked and held to the robotic arm by any mechanical, pneumatic, or electrical forces such that they can be controlled for positioning and release. Illustrations 1004 and 1608 on the right depict the robotic arm 1608 moving into position for placement of the label into either the male tool 414 or female 408 tool. The timing and geospatial positioning of the robotic arm 1608, the label 1004, the male tool 412, and the female tool 408 are precisely synchronized as independent components, and as an integrated system. The timing and geospatial positioning is such that no component impacts another component in a hazardous, or unplanned manner. Illustrations 1004 and 1608 utilizing the precise timing and geospatial referenced above are then moved inside the tooling 412 and 408 when it opens. These movements are controlled in a manner described above. Illustrations 1004 and 1608 utilizing the precise timing and geospatial referenced above are then moved to place the label 1004 into intimate contact with the individual tool (male or female, 412, 408). These movements are controlled in a manner described above. Further reference on the placement is made in FIGS. 11A, 11B, 8A, 8B. FIG. 15 further depicts the placement and adhesion of the label 1004 to the male or female tool 412,408. The label 1004 is released from the robotic arm 1608, and captured by the tool 412,408 and retained by the tool through forces such as pneumatic, hydrostatic, electrostatic, or other mechanical processes.

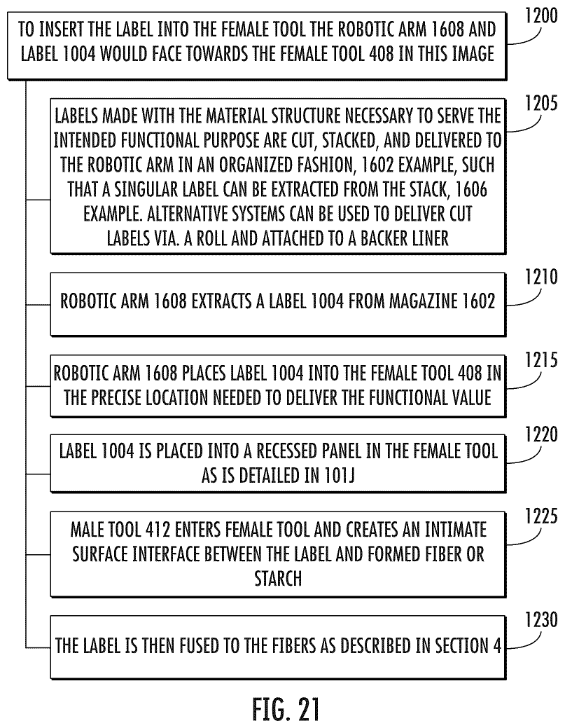

FIG. 21 shows process 1200-1230 further describes the placement of label into female tool. In step 1205, the labels are presented to the robotic arm in an organized fashion to retain the position and orientation and in a manner to enable highly consistent selection of a single unit in an automated process. The process can include cut stacks, or roll stocks of labels using a backer film. In step 1210, a multi-axis robotic arm with an aperture suitable for gripping a single label is utilized to select a label from the inventory described in FIG. 21 1605. In step 1215, the robotic arm and aperture are positioned in a synchronistic fashion to the geospatial location and time to coordinate with the opening of the male and female tools such that the label can be precisely placed into the female tool in the location formed for placement as described in FIG. 18. In step 1220, the female tool, adjusted using the methodologies described within and detailed in FIG. 18. holds the label, commonly in direct contact with the fibers. In step 1225, the male tool, commonly with the fibers adhered then enters the female tool. The female tool with the label applied is then pressed against the male tool with the fibers to dry and iron the surface and creating a bond between the fibers and the label. In step 1230, the female tool is heated and in direct contact with the fibers and label dries the material under pressure. The time and temperature and compatible materials create a bond to intimately fuse the materials to a finished product.

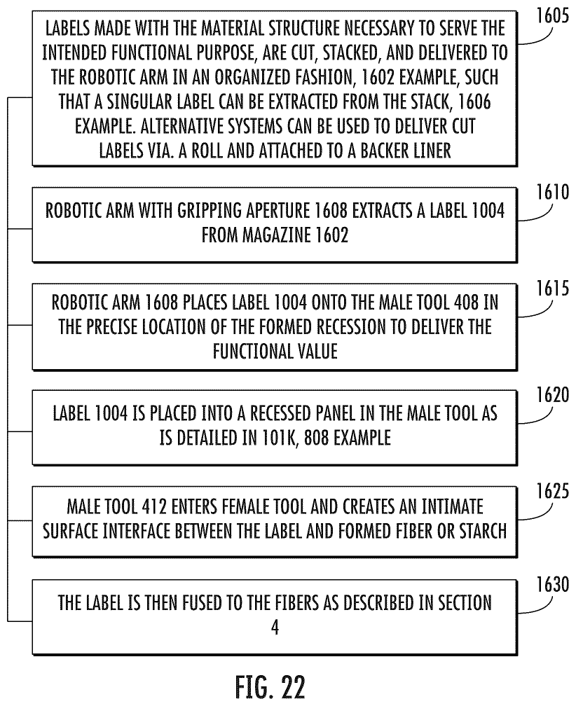

FIG. 22 shows process 1605-1630 which further describes the placement of label into male tool. In step 1605, the labels are presented to the robotic arm in an organized fashion to retain the position and orientation and in a manner to enable highly consistent selection of a single unit in an automated process. The process can include cut stacks or roll stocks of labels using a backer film. In step 1610, a multi-axis robotic arm with an aperture suitable for gripping a single label is utilized to select a label from the inventory described in FIG. 22 1605. In step 1615, the robotic arm and aperture are positioned in a synchronistic fashion to the geospatial location and time to coordinate with the opening of the male and female tools such that the label can be precisely placed onto the male tool in the location formed for placement as described in FIG. 20. In step 1620, the male tool, adjusted using the methodologies described within and detailed in FIG. 20. holds the label, commonly in direct contact with the fibers. In step 1625, the male tool, commonly with the fibers, and the label adhered then enters the female tool. The female tool is commonly heated for drying and ironing of the fibers. In step 1630, the female tool is heated and in direct contact with the fibers and label dries the material under pressure. The time and temperature and compatible materials create a bond to intimately fuse the materials to a finished product.

The use of the terms male tooling and female tooling in the processes described in FIG. 14A can be substituted to accommodate the specific features desired for the finished formed package or container.

Any number of geometries, shapes, or structural designs apply to the manufacturing process described in 101G and the shapes shown in the drawing provide an example of one embodiment.

Referring now to FIG. 14B, illustration 101W provides an exemplary embodiment of the systems utilized for the placement of a discrete in mold preform 1006 into a male 412 or female tool 408. Illustration 1602 and 1606 detail the processes described in FIG. 13B. Illustrations 1006 and 1608 depict a single preform 1006 being picked from system FIG. 13B and held by the robotic arm 1608. The preforms may be picked and held to the robotic arm by any mechanical, pneumatic, or electrical forces such that they can be controlled for positioning and release. Illustrations 1006 and 1608 on the right depict the robotic arm 1608 moving into position for placement of the preform into either the male 412 or female 408 tool. The timing and geospatial positioning of the robotic arm 1608, the preform 1006, the male tool 412, and the female tool 408 are precisely synchronized as independent components, and as an integrated system. The timing and geospatial positioning is such that no component impacts another component in a hazardous, or unplanned manner. Illustrations 1006 and 1608 utilizing the precise timing and geospatial referenced above are then moved inside the tooling 412 and 408 when it opens. These movements are controlled in a manner described above.

Illustrations 1006 and 1608 utilizing the precise timing and geospatial referenced above are then moved to place the preform 1006 into intimate contact with the individual tool (male or female, 412, 408). These movements are controlled in a manner described above. Further reference on the placement is made in FIGS. 11A, 11B, 9B, 9C, 8A.

FIG. 15 provides reference for the placement and adhesion of the label 1004 to the male or female tool 412,408. The preform can be positioned in a similar manner. The preform 1006 is released from the robotic arm 1608, and captured by the tool 412,408 and retained by the tool through forces such as pneumatic, hydrostatic, electrostatic, or other mechanical processes.

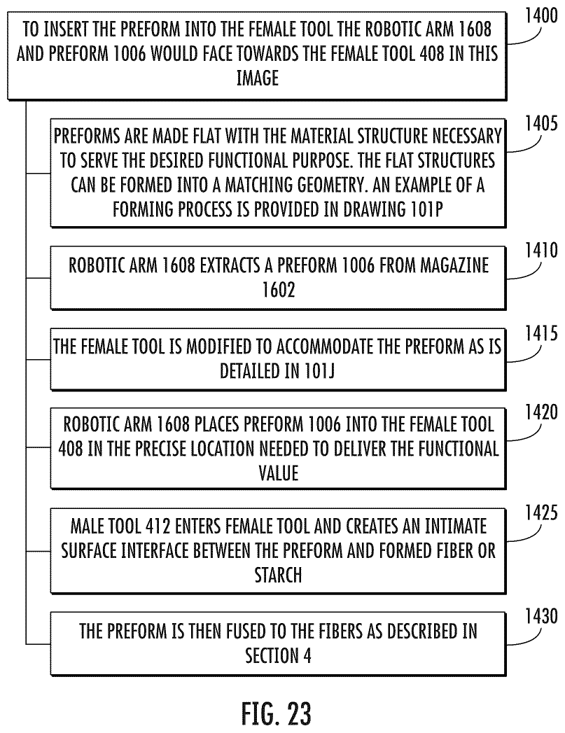

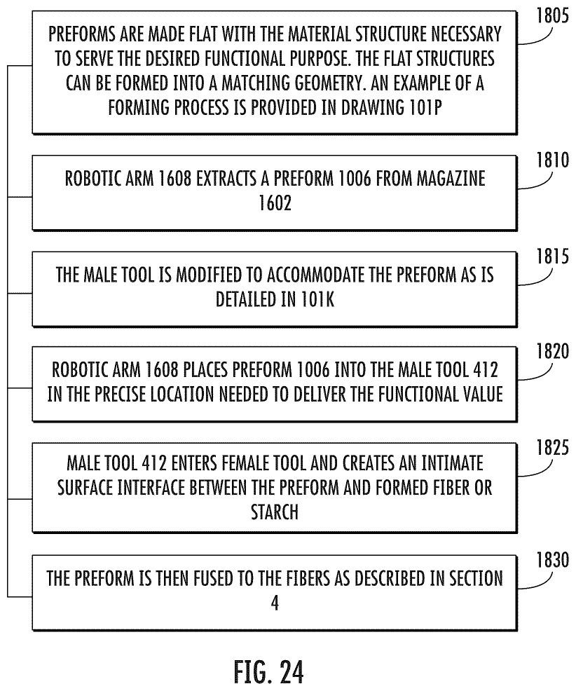

FIG. 23 shows process 1400-1430 which further describes the placement of preform into female tool. FIG. 24 shows process 1805-1830 which further describes the placement of preform onto male tool. In step 1805 of FIG. 24, the preforms are presented to the robotic arm in an organized fashion to retain the position and orientation and in a manner to enable highly consistent selection of a single unit in an automated process. In step 1810 of FIG. 24, a multi-axis robotic arm with an aperture suitable for gripping a single preform is utilized to select a preform from the inventory described in FIG. 24 1805. In step 1815 of FIG. 24, the robotic arm and aperture are positioned in a synchronistic fashion to the geospatial location and time to coordinate with the opening of the male and female tools such that the preform can be precisely placed onto the male tool in the location formed for placement as described in FIG. 20. In step 1820 of FIG. 24, the male tool, adjusted using the methodologies described within and detailed in FIG. 20, holds the preform, commonly in direct contact with the fibers. The preform is commonly held in place by vacuum, by gravity, by hydrostatic forces, or other forces engineered to retain the preform in position relative to the fibers and tooling. In step 1825 of FIG. 24, the male tool, commonly with the fibers, and the label adhered then enters the female tool. The female tool is commonly heated for drying and ironing of the fibers. In step 1830 of FIG. 24, the female tool is heated and in direct contact with the fibers and label dries the material under pressure. The time and temperature and compatible materials creates a bond to intimately fuse the materials to a finished product.

The use of the terms male tooling and female tooling in the processes described in FIG. 14A can be substituted to accommodate the specific features desired for the finished formed package or container.

Any number of geometries, shapes, or structural designs apply to the manufacturing process described in 101G and the shapes shown in the drawing provide an example of one embodiment.

Referring now to FIG. 15, illustration 101W provides an exemplary embodiment of the systems utilized for the placement of a discrete label 1004 or preform 1006 (not shown) into a male 414 or female 408 (not shown) tool. The robotic arm 1608 is presenting a label 1004 to a male tool 414. The label 1004 is precision placed around each male tool 414 and specifically into the recessed area 1612 as detailed in FIG. 11B, 8A, 8B. The label 1004 is precision designed for geometric configurations to fit in the recessed area 1612. The geospatial placement and timing of the robotic arm 1608 movement as described in FIG. 14B applies and is critical. The label 1004 may be released from the robotic arm 1608 and captured by either the male 414 or female 408 (not shown) tool, at position 1612 as a hand-off. (Not shown, on female tooling applications 408). The hand-off may be accomplished using vacuum, air pressure, mechanical pressure, surface tension, electro-static, hydrostatic, coefficient of friction, or other types of placing devices. The motion for placement of each label 1004 may be a perpendicular hand-off, or a sweeping motion to accommodate surface geometries, wrapping, or tool movement.

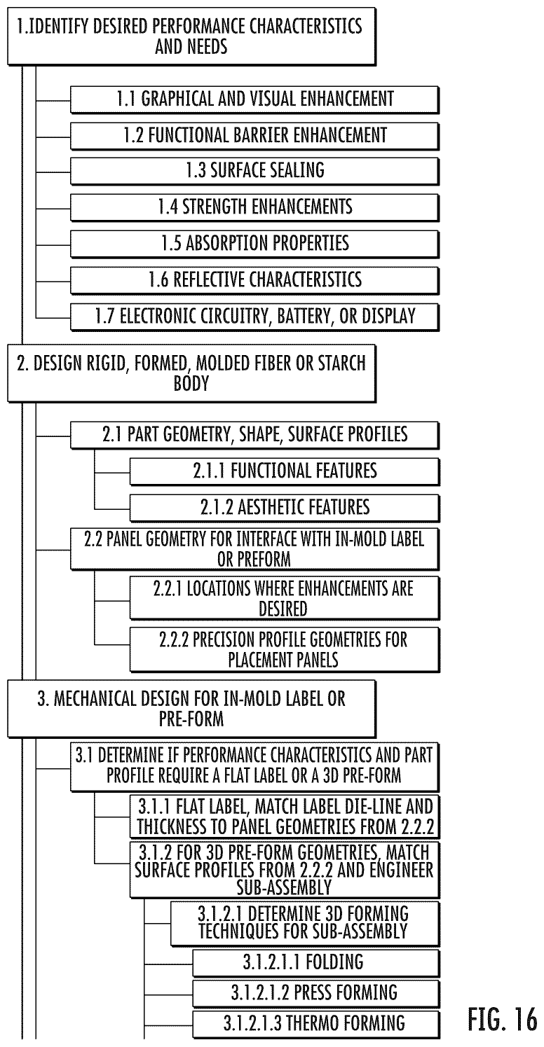

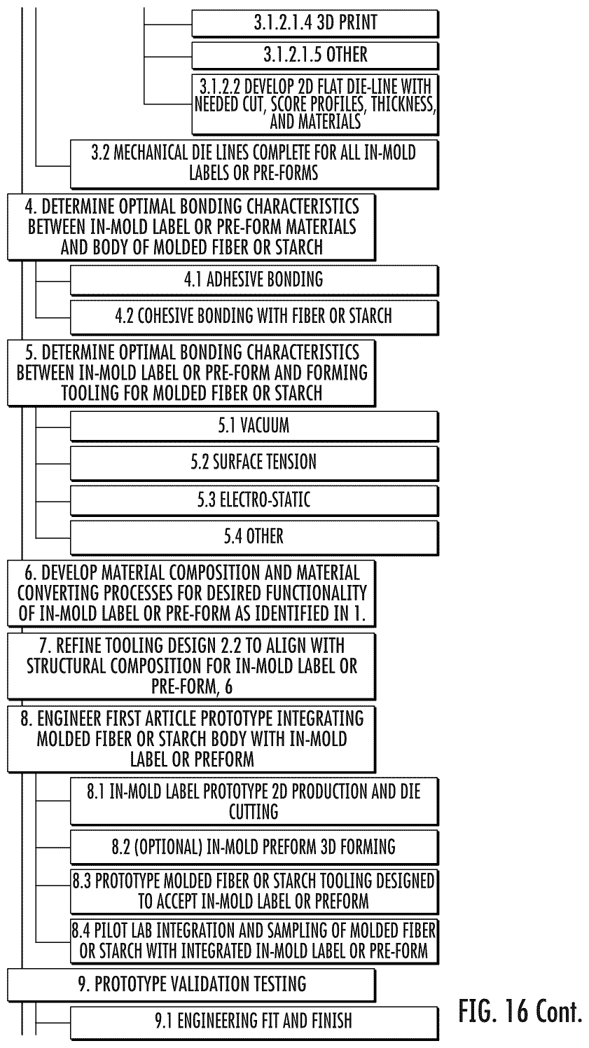

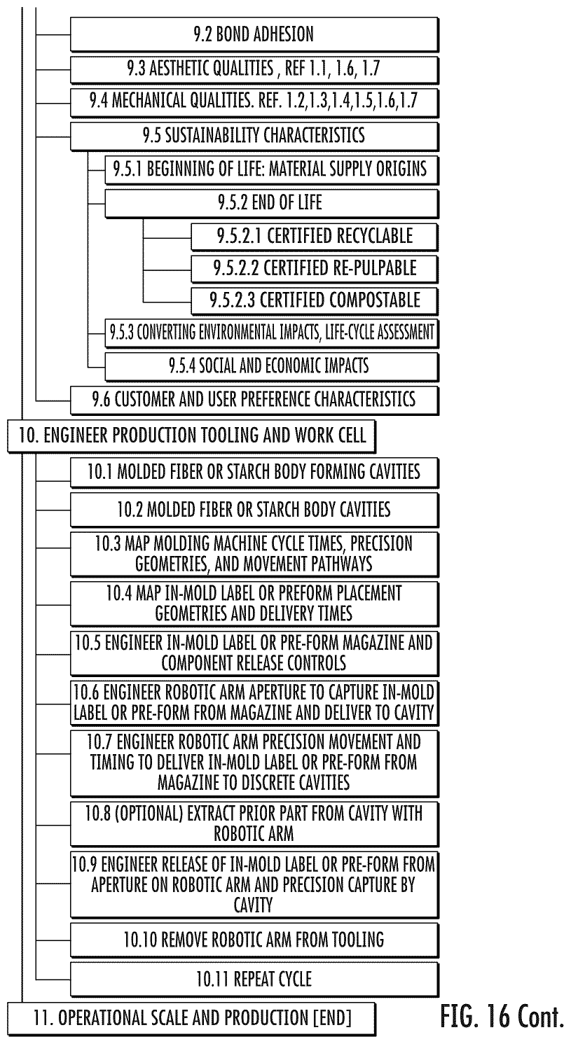

FIG. 16 shows a method of using in-mold label or pre-form to functionally or visually enhance performance for rigid, formed, molded fiber and starch-based containers.

Step 1. Identify Desired Performance Characteristics and Needs-The functional and visual performance characteristics for the finished product are to be determined. These attributes are commonly established based on consumer use, retail, supply chain, converting, environmental, technical-regulatory, economics, and Sustainability considerations. Specific to the devices, systems, and methods disclosed herein, the following attributes are to be examined and defined:

1.1. Graphical and Visual Enhancement-Defining the desired graphical communication includes visual representations, branding, use instructions, ingredients, safety labeling, and technical regulatory copy. Such attributes are to be placed on discrete die-lines and the desired placement of the graphics on the molded fiber or starch body is to be defined.

1.2. Functional Barrier Enhancement-Functional barrier can include a multitude of attributes for different products and can be used to protect the product from external influences, or be applied to prevent internal environmental characteristics from escaping the packaging system. Barrier requirements are unique to each product; however, common attributes include water, water vapor, oxygen, carbon dioxide, nitrogen, UV light, chemical resistance, electrical charges, grease, and thermal barrier (hot or cold).

1.3. Surface Sealing-Sealing characteristics provide solutions to contain products within the package, to ensure barrier characteristics are maintained, to provide easy-open features, to provide tamper-evident, tamper resistant packaging, or re-seal features. Sealing characteristics can also be applied to adhere the package to an adjacent product. In implementing the system solution defined within it is necessary to understand the specific geometric locations where sealing is needed, the desired sealing characteristics to include sealing strength, seal methodologies, and defining the opposing structure that will bind to the body of molded fiber or starch.

1.4. Strength Enhancements-Strength enhancements can deliver functional performance for a packaging system. Specific to the devices, systems, and methods disclosed herein, is the ability to discretely apply those strength enhancements to molded fiber and starch. In developing solutions using the devices, systems, and methods disclosed herein, the desired strength enhancement, the desired location benefiting by the enhancement, and the material used to deliver that strength is to be defined. An example might be the use of a high-strength fiberboard adhered to the corners of a molded fiber solution. Another example might be the use of fiber with flexural tensile properties to re-enforce a hinge. Another example might be the use of a high-strength fiberboard to provide horizontal or torsional stiffness. Another example might be to provide molded fiber with rebound properties to sustain repeat impacts. In determining the benefit for such strength enhancements, prototypes can be constructed by hand through the use of an adhesive to augment inserts on to the body of molded fiber or starch in discrete locations. The augmented parts can be tested to demonstrate and predict quantifiable improvements. [Cite Patent: 3]

1.5. Absorption Properties-Products that would benefit by absorption properties will need to identify the size of the product surface area, the amount of fluids, and the location where absorption is needed. An example of this might be poultry and the need to have an integrated absorption pad. The devices, systems, and methods disclosed herein enables the augmentation of molded fiber or starch with an absorptive pad that can be recycled or composted with characteristics that are consistent with the body of molded fiber or starch.

1.6. Reflective Characteristics-Reflection can deliver value for a multitude of use applications to include thermal reflection, signal reflection, or energy redirection. The type of energy or signal to be reflected is to be defined along with details on the desired direction for reflection. An example of this might be the reflective surface for baked goods to deliver a crust. Another example might be reflective characteristics to concentrate or disperse electronic signals. Another example might be a purely decorative application.

1.7. Electronic Circuitry, Battery, or Display-Emerging technologies for low-cost printed electronics, electric circuitry, OLED/LEDs, and power supplies create an opportunity to be integrated into high volume consumer goods. The devices, systems, and methods disclosed herein provide a pathway for such technologies to be integrated to molded fiber or starch. To accomplish this, the discrete components need to be defined in size, shape, and weight. The precise placement geometry is also required for placement and integration with the body of molded fiber or starch.

Step 2. Design Rigid, Formed, Molded Fiber or Starch Body.

2.1. Part Geometry, Shape, Surface Profiles-Given the desired attributes defined in section 1 above, the geometric shape and profile for the body of molded fiber or starch is to be created. The structural design will include functional, strength, and aesthetic features. Specifically to the devices, systems, and methods disclosed herein, the surfaces that are to be augmented require discrete consideration for the number of surfaces, the geometric location, the panel size, angular orientation, and adjacent features of the part. The geometric design for the body of molded fiber or starch will be done simultaneous with the design of the integrated inserts of section 3, the insert material composition of section 6 (thickness being critical), the tooling of section 7, and the machine movements in section 10. This is best accomplished in digital three-dimensional computer automated design (CAD) software that enables integration and simulation for placement.

2.1.1. Functional features-specific design attributes of 2.1. An example might be the need for a flange with a smooth sealing surface.

2.1.2. Aesthetic features-specific design attributes of 2.2. An example might be the need for printed graphics to include technical regulatory requirements for use instructions.

2.2. Panel Geometry for Interface with In-Mold Label or PreForm-The type of forming processes used will define the tool(s) and associated male/female geometries. For placement of the in-mold label or preform, consideration is necessary for the tool movement between the male and female tool to ensure the tools can move freely as they engage. The in-mold label or pre-form is to be adhered to the tool in a recessed cavity. In Type 2 or Type 3 thermoforming, this can be a recessed panel in the female tool of the drying tool. An alternative iteration could be a recessed panel on the male forming tool. In dry molded fiber, or baked starch applications, the recessed cavity can be in either the male or the female tool. The cavity recess is to be commensurate with the thickness of the in-mold label or preform such that the end result is a flush presentation on the surface.

2.2.1. Locations where enhancements are desired-Enhancements can be made to the internal or external surfaces of the finished part as described within. The placement of the in-mold label or pre-form on the body of molded fiber or starch will therefore need to be engineered simultaneous with the tool design for the body. The placement can be either in the male or female tool so the end product is presented with the orientation as desired. Commonly, the male tool represents the interior surface and the female tool represents the exterior surface.

2.2.2. Precision profile geometries for placement panels-the precision coordinates in the tooling for placement of the in-mold label or preform (x,y,z) are required. Systems development using digital three-dimensional computer automated design (CAD) software will be necessary as the placement location will be used to guide the robotic arm for movement in and out of a mold tool that is opening and closing.

Step 3. Mechanical Design for In-Mold Label or Pre-Form

3.1. Determine if performance characteristics and part profile require a flat label or a 3D pre-form-To deliver the design objectives in section 1, in consideration of the structural designs in section 2, a decision is made if this can be accomplished with flat label(s), or if three dimensional preform is needed. Decision criteria include the position and angle of the desired surface for augmenting, the need for multiple surfaces to be augmented, the continuity of the surface, and the movement of the tool for speeds and placements. One example might be the desire to deliver functional high-barrier. In this example full surface coverage is required and likely to include a smooth flange or surface for sealing; making a preform more appropriate. Another example could be the desire to provide high impact, visually stimulating graphics with fine print. In this example, a flat label might be appropriate.

3.1.1. Flat label, match label die-line and thickness to panel geometries from 2.2.2.

3.1.2. For 3D pre-form geometries, match surface profiles from 2.2.2 and engineer sub-assembly. In constructimg a pre-form solution, the surface is defined in three-dimensional space and then the optimal forming converting technology is explored as a sub-assembly. In high-volume consumer packaging with natural and renewable materials, this is commonly accomplished with folding, press forming, thermoforming, or 3D printing.

3.1.2.1. Determine 3D forming techniques for sub-assembly.

3.1.2.1.1. Folding—Multiple converting technologies commonly found in carton manufacturing can be used. Such technologies include cutting, scoring, folding, and sealing of structures to obtain the desired geometry. As an example, a strength enhancement pre-form can be made with fiberboard scored with angles. Another example might be a pre-form tray made on high speed folding, gluing lines.

3.1.2.1.2. Press Forming—A forming process to which materials can be subjected to high pressure between opposing tools to force fiberboard or other materials into a preformed shape. Press Forming in this context is primarily accomplished with blanks that are cut and scored. An example of this might be a press-formed bowl.

3.1.2.1.3. Thermoforming—Is a technology traditionally applied to the plastics domain; however emerging technologies are demonstrating the solution with fiber.

Thermoforming can be used to create a three-dimensional surface from a flat material web. An example of thermoforming might be the creation of a multi-cavity part such as a segmented school lunch tray.

3.1.2.1.4. 3D Print—3D printing is a known technology to generate contoured and formed surfaces.

3.1.2.1.5. Other—Any other manufacturing technology to create a 3D formed surface out of materials compatible with molded fiber or starch to preserve the Sustainability value for recyclability or compostability as an integrated system.

3.1.2.2. Develop 2D flat die-line with needed cut, score profiles, thickness, and materials. Any of the above processes can be used to manufacture the three-dimensional pre-form. The three-dimensional design is to be translated to a flat die-line with the appropriate cut and score profiles.

3.2. Mechanical die lines complete for all in-mold labels or pre-forms.

Step 4. Determine optimal bonding characteristics between in-mold label or pre-form materials and body of molded fiber or starch. Bonding characteristics are best validated with the use of a prototype tool and pilot lab. The bonding will be dependent on the fibers and starches selected for use on the molded body, and the materials selected for the label or preform. Bonding can be accomplished through cohesive fusion of fibers as the moisture is evacuated from the formed body, or an adhesive bond can be utilized, or a combination of the two. The heat from the molding tool can be used to activate an adhesive layer between the label or pre-form and the body of molded fiber or starch. When an adhesive bond is used, the adhesive bond layer is applied to the label or the pre-form and applied to the surface the will interface with the molded fiber or starch in the tool. Other considerations for bonding strength will be the cohesive properties of the fibers or starch body.

4.1. Adhesive bonding-Common adhesives used for bonding with fibers include water-based, bio-polymer based, lignin-based, solvent-based, and 100% solid adhesives. Materials can include, but not limited to, starch, cellulose, protein, casein, animal glue-gelatin, natural rubber, latex, polyvinyl acetate, polyvinyl alcohol, lignin, polyurethanes, acrylics, and others.

4.2. Cohesive bonding with fiber or starch-The in-mold label or pre-form is presented to the body of molded fiber or starch at a manufacturing process where the fibers or starches are not fully mechanically set. The surface still contains moisture with the fibers semi-suspended. The moisture is being actively extracted, commonly under heat and pressure. As such, the label can be manufactured of a compatible material to the body such that the interface creates an intimate bond with the body as moisture is extracted under pressure. An example might be a cohesive fiber to fiber bond. Another example might be a cohesive fiber to starch bond.

Step 5. Determine optimal bonding characteristics between in-mold label or pre-form and forming tooling for molded fiber or starch. The label or preform will be presented to the forming tool by a robotic arm. The aperture on the robotic arm will release and transfer the label or pre-form to the tool. The tool will be engineered to receive the hand off of the label or preform. The receiving mechanics in the tool can be a vacuum, electrostatic, surface tension, or other. In wet molded fiber processes, vacuum is commonly available. Wet molded fiber also provides opportunity for surface tension bonding. On dry molded fiber, or baked starch processes an additional option is electro-static.

5.1. Vacuum-use of vacuum to hold the in-mold label or preform to the forming tool.

5.2. Surface Tension-use of surface tension characteristics on a wet surface to hold the in-mold label or preform to the forming tool.

5.3. Electro-static-use of low levels of electrical current to hold the in-mold label or preform to the forming tool.

5.4. Other-any other methodologies available to hold the label or preform to the tooling.

Step 6. Develop material composition and material converting processes for desired functionality of in-mold label or pre-form as identified in 1. The material composition for the label or preform is critical to deliver the desired functionality for the integrated innovation detailed within. Multiple existing technologies are available for high-speed, and economic conversion to deliver these functional attributes in flat and folded geometric profiles. The devices, systems, and methods disclosed herein focus on the integration of these technologies with those of molded fiber or starch. The integration of the two technologies delivers a transformative product. Some examples of material compositions to be used can include, but not limited to, papers, fiberboard, corrugated, foils, biopolymer films, biopolymer rigid, laminations, or any combination of the above. The base materials can be further customized to enhance performance characteristics through secondary processes, some examples of which might include-metallizing, foil stamping, laminating, printing, aqueous coatings, solvent coatings, extrusion coatings.

Step 7. Refine tooling design 2.2 to align with structural composition for in-mold label or pre-form, 6. Refining of the tool is done to accommodate the final geometric thickness of the substrate selected in section 6 with the die line from section 3.

Step 8. Engineer first article prototype integrating molded fiber or starch body with in-mold label or preform.

8.1. In-mold label prototype 2D production and die cutting-production trials, or laboratory simulations can be used to establish the base materials and 2D geometries for the label or pre-form. Sample development can be sequenced to isolate each attribute for the desired aesthetic or functional applications covered within, and subsequent validation testing. As one example—A paper label can be digitally printed with high impact graphics, a surface varnish applied, and heat activated coating applied. The label can be cut to the precise dimensions for integration to the panel on the body of the molded fiber or starch.

8.2. (Optional) In-mold preform 3D forming-Once functional and aesthetic attributes are developed for the 2D structure, the material can be pre-formed into the desired 3D shape. The forming process can be accomplished in laboratory simulations, or full scale production. As one example-A paper, or paperboard can coated or metallized to provide high barrier properties. Each surface can be custom coated with a heat activated sealants to which the individual sealants can activate under different conditions (example: different glass transitions temperatures, Tg for thermal activation). The paperboard can then be press-formed to create a matched geometry to the inner profile of molded fiber and starch. The preform can then be precision placed for integration to the panel on the body of molded fiber or starch.

8.3. Prototype molded fiber or starch tooling designed to accept in-mold label or preform. The prototype tool enables testing and validation of computer simulation modeling. Details on validation are reviewed in Section 9.

8.4. Pilot lab integration and sampling of molded fiber or starch with integrated in-mold label or pre-form. Integration provides the first review of the full package system as intended. It is at this time the in-mold label or pre-form is fused to the body of molded fiber or starch. With the two systems combined, the finished product is now available for review and evaluation to the desired intended purpose.

Step 9. Prototype validation testing-The innovation within is a system solution and pre-production validation is critical. Validation is recommended at every prior process step outlined within. Early identification and correction provides maximum opportunity and efficiency to achieve design objectives. Validation is recommended for 1) The base material configuration for the in-mold label or pre-form, 2) The base material configuration for the molded fiber or starch, 3) The forming process to produce the pre-form, 4) The final geometries for the in-mold label or preform, 5) The final geometries for the molded fiber or starch body. Final assembly validation enables the full system to be tested for functional and aesthetic characteristics. Common physical performance attributes for validation testing include dimensions, weight, strength, barrier properties, print quality, and surface properties. Validation testing for sustainability properties should also be completed-testing for recyclability or compostability of the finished product. After prototype validation is complete, full production validation should be conducted for each component of the sub-assembly to validate repeatability and economics. A few specific validation points are summarized below:
9.1. Engineering fit and finish
9.2. Bond adhesion
9.3. Aesthetic qualities, Ref 1.1, 1.6, 1.7
9.4. Mechanical qualities. Ref. 1.2, 1.3, 1.4, 1.5, 1.6, 1.7
9.5. Sustainability characteristics
9.5.1. Beginning of life: Material supply origins
9.5.2. End of Life
9.5.2.1. Certified Recyclable
9.5.2.2. Certified Re-Pulpable
9.5.2.3. Certified Compostable
9.5.3. Converting Environmental Impacts, Life-Cycle Assessment
9.5.4. Social and Economic Impacts
9.6. Customer and user preference characteristics

Step 10. Engineer Production Tooling and Work Cell-With validation complete for the sub-assembly manufacturing processes, and the assembled physical performance characteristics, consumer use, and commercial economics; then engineering of the automated assembly is ready to begin.

10.1. Molded fiber or starch body forming cavities-Final selection of converting technologies, and discrete machines to be used for production of the body of molded fiber and starch. For each machine, critical profile information is required to include: upstream and downstream machine speeds, integration and logic control systems, mold open/close dimensions, mold open/close speeds and acceleration.

10.2. Molded fiber or starch body cavities-Custom tooling is required to create the innovation within. The tooling is designed with specific purpose, for each structural design. To engineer the integration, the intimate details of the tools 3D geometry are required. Further, how the tooling is mounted into the specific machine will need to be molded into digital CAD systems.

10.3. Map molding machine cycle times, precision geometries, and movement pathways-With machine, tooling, and part geometries defined in digital CAD systems; the system is to be set into motion to calculate precise movements and time at the full portfolio of speeds.

10.4. Map in-mold label or preform placement geometries and delivery times-The geo-spatial pathways are to be mapped to time showing precise X,Y,Z coordinates at time

10.5. Engineer in-mold label or pre-form magazine and component release controls-The in-mold label or pre form will be inventoried and presented for individual pick access by the robot. This is primarily done by placing the individual components into a magazine with metered tack-offs at the end. For flat labels, an alternative configuration could be to deliver discrete items from a roll and flag the discrete components from the roll through a sharp reverse angle of the web. The critical component is that the robotic arm has unobstructed access to capture the in-mold label or preform in a consistent manner without imparting unintentional manipulation or distortion of the label or preform. Further, environmental conditions should be considered to protect the pre-form or label from influence by external factors such as air/wind, static, thermal, humidity, dust, or other factors that could distort the positioning or characteristics of the label or preform.

10.6. Engineer robotic arm aperture to capture in-mold label or pre-form from magazine and deliver to tool-The robotic arm is to be fitted with an aperture that is designed to precisely capture the in-mold label or preform. The capture mechanisms are described in Section 5. The robotic arm aperture can be designed to capture an individual label or preform, or more likely, to capture an array of labels or preform. The number of items to be captured, and the robotic aperture design, is established based on the number of cavities in the tool, and the number of labels or preforms used for each tool. As an example: A 9 cavity tool with two labels each would have a robotic aperture to grab 18 labels.

10.7. Engineer robotic arm precision movement and timing to deliver in-mold label or pre-form from magazine to discrete cavities-This is the most critical machining component of the manufacturing process and is engineered through 3d digital programming in CAD systems. All machine movement, upstream and downstream dependencies, and geo-spatial speeds are to be mapped into the digital model. Simulation is then conducted with the system in motion. The robotic arm, aperture, and label (or preform) need to enter the tool while it is open, transfer the label or preform to the tool cavity (male or female), and then exit the tool before the tool closes for the next cycle. The movements are precise and fluid so as to not crash the system. When the robotic arm and aperture are not inside the tool, they are actively collecting the in-mold label or preform for the next cycle. The timing of the process, and support systems, are to be optimized for maximum efficiency with the goal of not slowing the production cycle. This includes the consideration for multiple feed systems, aperture and robotic designs, motion pathways, and accelerations.

10.8. (Optional) Extract prior part from tool with robotic arm-With the robotic arm inside the tool to place the in-mold label or preform, it is often beneficial to have the robot simultaneously extract the finished formed part from the tool.

10.9. Engineer release of in-mold label or pre-form from aperture on robotic arm and precision capture by tool-Each component will have its own release and capture mechanism. Most commonly that is vacuum; however, alternate options are explored in Section 5. In a very consistent, precise, and fluid manner; the label or preform will be released from the robotic aperture and captured by the tool. This is done in intimate proximity and digitally sequenced for repeatability. The X,Y,Z, and time movements covered in section 10 applies to this intimate hand off.

10.10. Remove robotic arm from tooling.

10.11. Repeat cycle.

Step 11. Operational scale and production.

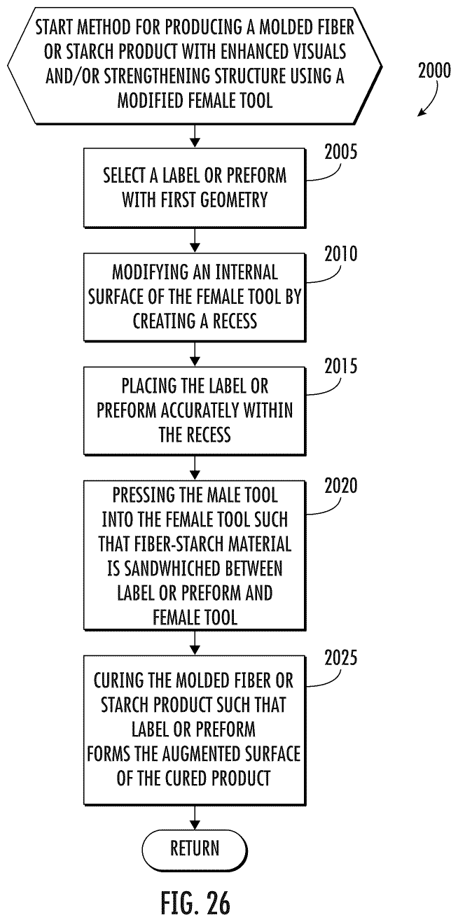

Referring now to FIG. 26, this figure illustrates a logical flow chart 2000 for a method for producing a molded fiber or starch product with visual and/or functional enhancements using a modified female tool. Step 2005 is the first step of method 2000 and includes selecting a label 1202 or preform 101R such as illustrated in FIGS. 10B, 10C and FIGS. 12A-12D.

Next, in step 2010, an internal surface of a female tool 410 of FIG. 8A is modified. Specifically, the internal surface of the female tool 410 is modified by creating a recess 703 that has a geometry that matches the label 1202 or preform 101R. Subsequently, in step 2015, the label 1202 or preform 101R is placed accurately within the recess 703 of the female tool 410 as illustrated in FIGS. 14A and 14B, by using a robot arm 1608. FIG. 9B further demonstrates a preform being inserted into a female tool.

Next, in step 2020, a male tool 1502 may be pressed into female tool 1504 such as illustrated in FIG. 11A, where the female tool 1504 contains the recess 703. This step 2020 starts the creation of the products as illustrated in examples FIGS. 1A, 1B, 2, 3A, 3B, 4, 5, 6 with an augmented surface.

Subsequently, in step 2025, the molded fiber or starch product is cured such that the label 1202 or preform 101R forms the augmented surface of the molded fiber product as illustrated in examples FIGS. 1A, 1B, 2, 3A, 3B, 4, 5, 6. The method/process 2000 may then return/may be repeated.

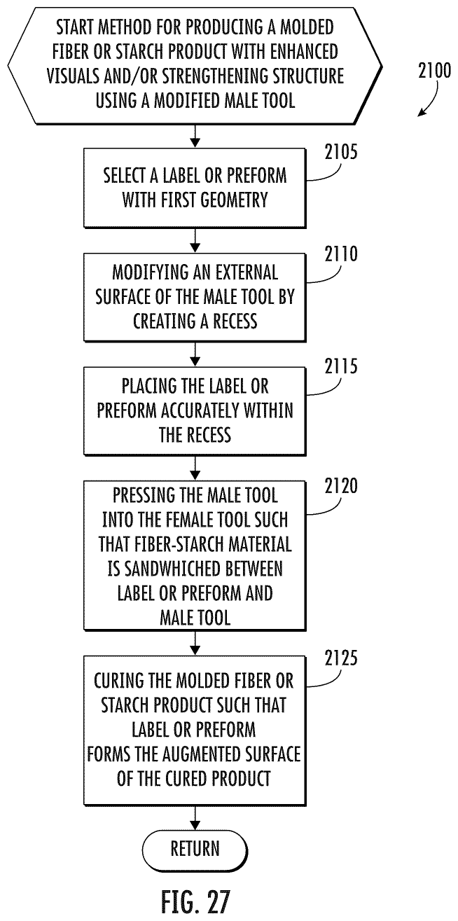

Referring now to FIG. 27, this figure illustrates a logical flow chart 2100 for a method for producing a molded fiber or starch product with visual and/or functional enhancements using a modified male tool. Step 2105 is the first step of method 2000 and includes selecting a label 1202 or preform 101R such as illustrated in FIGS. 10B, 10C and FIGS. 12A-12D.

Next, in step 2110, an external surface of a male tool (i.e. 414 of FIG. 8B and/or 1502 of FIG. 11A, and/or 1015 of FIG. 9C) is modified. Specifically, the external surface is modified by creating a recess 808 that has a geometry that matches the label 1202 or preform 101R.

Subsequently, in step 2115, the label 1202 or preform 101R is placed accurately within the recess 808 of the male tool 414/1502 as illustrated in FIGS. 14A and 14B, by using a robot arm 1608.

Next, in step 2120, the male tool 414/1502 may be pressed into a female tool 1504 such as illustrated in FIG. 11A. In this embodiment, the male tool 414/1502 has the recess 808 for the label 1202. This step 2120 starts the creation of the product as illustrated in examples FIGS. 1A, 1B, 2, 3A, 3B, 4, 5, 6. with an augmented surface.

Subsequently, in step 2125, the molded fiber or starch product is cured such that the label 1202 or preform 101R forms the augmented surface of the molded fiber product as illustrated in examples FIGS. 1A, 1B, 2, 3A, 3B, 4, 5, 6. The method/process 2100 may then return/may be repeated.

Certain steps in the processes or process flows described in this technical specification naturally precede others for the methods disclosed herein to function as described. However, the methods disclosed herein are not limited to the order of the steps described if such order or sequence does not alter the functionality of the method. That is, it is recognized that some steps may performed before, after, or parallel (substantially simultaneously with) other steps without departing from the scope and spirit of the devices, systems, and methods disclosed herein.

In some instances, certain steps may be omitted or not performed without departing from the methods disclosed herein. Further, words such as “thereafter”, “then”, “next”, etc. are not intended to limit the order of the steps. These words are simply used to guide the reader through the description of the exemplary method.

It is noted that several of the figures provide exhaustive detail which would allow one of ordinary skill in the art to make, build, and use the system as intended. Thus, the several figures of this disclosure are enabling to one of ordinary skill in the art. Further, text explanations may not be necessary for several of the figures since the old axiom holds true for the attached figures: a picture is worth a thousand words, as understood by one of ordinary skill in the art.

With the figures being enabled to one of ordinary skill in the art, they provide sufficient structure and detail that may be claimed in a non-provisional as set forth in 37 C.F.R. 1.83(a). That is, the drawings of the present application may be used in a nonprovisional application, since they show every feature of the devices, systems, and methods disclosed herein that may be specified in the claims for a nonprovisional case.

It is further noted that each figure has been drawn to scale relative to each part that is illustrated in a particular figure. That is, for each figure, each respective component or each part has been drawn to scale relative to other parts that are illustrated in the same figure. Therefore, the sizes of each part have been illustrated according to their respective and relative size that is depicted in each figure.

For example, FIGS. 1A and 1B, illustrate an exemplary container 101A. Each container 101A has a curved, walled bottom section/part 35 as well as a top, domed structure 25A. The bottom part 35 has a first diameter, while the top structure 25A has a second diameter.

The diameters for both bottom part 35 and structure 25A are substantially equal. Meanwhile, FIG. 1A shows the container 101A with a slightly higher magnification compared to the container 101A illustrated in FIG. 1B. This means that the relative sizing of the first diameter of part 35 compared to the second diameter of part 25A should remain consistent within the remaining figures that have been provided in this disclosure.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A method for producing a molded fiber or starch product, the method comprising:
obtaining a label or a preform having a first geometry;
obtaining one of a male tool or a female tool, wherein a recess defined as a recessed panel is defined in an external surface of the male tool or an internal surface of the female tool, wherein the recess has a second geometry that corresponds to the first geometry of the label or preform, wherein the recessed panel has a depth commensurate with a thickness of the label or preform such that the label or preform presents a flush surface when disposed in the recess;
disposing the label or preform within the recess of the one of the male tool or the female tool;
obtaining an other of the female tool or the male tool;
pressing the male tool into the female tool such that a fiber-starch material is sandwiched between the label or preform and the other of the female tool or the male tool in order to form the molded fiber or starch product with the label or preform coupled to a surface of the molded fiber or starch product; and
curing the molded fiber or starch product such that the label or preform forms an augmented surface of the molded fiber or starch product once cured.

2. The method of claim 1, wherein the one of the male tool or the female tool comprises a male tool, and wherein the recessed panel is defined in the external surface of the male tool.

3. The method of claim 1, wherein the one of the male tool or the female tool comprises a female tool, and wherein the recessed panel is defined in the internal surface of the female tool.

4. The method of claim 1, wherein the label or preform comprises a plurality of layers.

5. The method of claim 1, wherein the label or preform comprises paper.

6. The method of claim 4, wherein one of the layers comprises metal.

7. The method of claim 4, wherein one of the layers comprises an adhesive.

8. The method of claim 1, wherein the fiber-starch material is recyclable, compostable, or biodegradable.

9. The method of claim 1, wherein the fiber-starch material comprises cellulose fibers made from virgin fibers, recycled paper, sugar-cane residues, corn stover, sugar beet residues, coconut husk including coir dust, cotton linters, citrus residues, sawdust, or particulated fibers prepared from coagula or extruded fibers of water-insoluble biopolymers including calcium alginate, hemp, miscanthus, elephant grass, rice straw, wheat straw, bagasse, switch grass, or any other natural fiber.

10. The method of claim 1, wherein the second geometry of the recess is the same as the first geometry of the label or preform.

11. The method of claim 1, wherein the recess defined by the one of the male tool and the female tool is a first recess, wherein the label or preform is a first label or first preform, wherein the other of the female tool or the male tool defines a second recess, the method further comprising:
disposing a second label or a second preform within the second recess prior to pressing the male tool into the female tool,
wherein the fiber-starch material is sandwiched between the second label or second preform and the one of the male tool or the female tool in order to form the molded fiber or starch product with the label or preform coupled to a second surface of the molded fiber or starch product, and
wherein, when the molded fiber or starch product is cured, the second label or second preform forms a second augmented surface of the molded fiber or starch product once cured.

12.-30. (canceled)
